(19) United States
(12) Patent Application Publication
(10) Pub. No.: US 2025/0224723 A1
(43) Pub. Date: Jul. 10, 2025

(54) METHODS AND APPARATUS TO MONITOR DEVICE PARAMETERS

(71) Applicant: Fisher-Rosemount Systems, Inc., Round Rock, TX (US)

(72) Inventors: Ying Xu, Maple Grove, MN (US); James Philip Kramer, Bloomington, MN (US); Steven Robert Dillon, Woodbury, MN (US); Fred Gene Middendorf, Chaska, MN (US); Anna Lovella Querubin Velena, Round Rock, TX (US)

(21) Appl. No.: 18/990,213

(22) Filed: Dec. 20, 2024

Related U.S. Application Data
(60) Provisional application No. 63/617,690, filed on Jan. 4, 2024.

(51) Int. Cl. G05B 23/02; G06F 16/3331

(52) U.S. Cl. CPC G05B 23/0286; G05B 23/0275; G06F 16/3331

(57) ABSTRACT

Disclosed examples include interface circuitry, first instructions, and programmable circuitry to at least one of instantiate or execute the first instructions to access a file in a request from a client device, the file including at least a second instruction to retrieve device parameter data associated with at least one field device in a process control system, convert at least the second instruction of the file from a first format to a field device request in a second format, cause access of a first device parameter value of the device parameter data in the at least one field device based on the field device request, query a database to retrieve a second device parameter value of the device parameter data, and provide the first device parameter value and the second device parameter value to the client device.

### RELATED APPLICATION

This application claims the benefit of U.S. Provisional Patent Application No. 63/617,690, filed Jan. 4, 2024. U.S. Provisional Patent Application No. 63/617,690 is hereby incorporated herein by reference in its entirety. Priority to U.S. Provisional Patent Application No. 63/617,690 is hereby claimed.

### FIELD OF THE DISCLOSURE

This disclosure relates generally to process control systems and, more particularly, to methods and apparatus to monitor device parameters.

### BACKGROUND

Data systems such as control systems, manufacturing automation systems, and other industrial systems like those in chemical, petroleum or other processes, may store data on a server to allow authorized users to access the data from any location. Such servers may be communicatively coupled to field devices operating in a process control system.

### BRIEF DESCRIPTION OF THE DRAWINGS

FIG. 1 is a block diagram of an example environment in which example parameter monitor circuitry operates to monitor device parameter data.

FIG. 2 is a block diagram of an example implementation of the example parameter monitor circuitry of FIG. 1.

FIG. 3 is a flowchart representative of example machine-readable instructions and/or example operations that may be executed, instantiated, and/or performed by programmable circuitry to implement the parameter monitor circuitry of FIGS. 1 and 2 to process an example input file that specifies device parameter data to be monitored.

FIG. 4 is a flowchart representative of example machine-readable instructions and/or example operations that may be executed, instantiated, and/or performed by programmable circuitry to implement the parameter monitor circuitry of FIGS. 1 and 2 to detect changes to a list of monitored field devices.

FIG. 5 is a flowchart representative of example machine-readable instructions and/or example operations that may be executed, instantiated, and/or performed by programmable circuitry to implement the parameter monitor circuitry of FIGS. 1 and 2 to monitor and/or read user-modifiable configuration parameters in the asset database of FIG. 1.

FIG. 6 is a flowchart representative of example machine-readable instructions and/or example operations that may be executed, instantiated, and/or performed by programmable circuitry to implement the parameter monitor circuitry of FIGS. 1 and 2 to read process variables from the field devices of FIG. 1.

FIG. 7 is a flowchart representative of example machine-readable instructions and/or example operations that may be executed, instantiated, and/or performed by programmable circuitry to implement the parameter monitor circuitry of FIGS. 1 and 2 to access device parameter data.

FIG. 8 is a block diagram of an example processing platform including programmable circuitry structured to execute, instantiate, and/or perform the example machine-readable instructions and/or perform the example operations of FIGS. 3-7 to implement the parameter monitor circuitry of FIG. 2.

FIGS. 9A-9G depict an example input file schema of FIGS. 1 and 2 in Javascript Object Notation (JSON) format.

FIGS. 10A-10B depict an example schema structure that may be used to implement the output schema of FIGS. 1 and 2 in JSON format.

FIGS. 11A-11B depict another example schema structure that may be used to implement the output schema of FIGS. 1 and 2 in JSON format.

FIGS. 12A-12D depict an example JSON input file having property values that may be used to implement the JSON input file schema of FIGS. 1 and 2.

FIG. 13 is a block diagram of an example implementation of the programmable circuitry of FIG. 8.

FIG. 14 is a block diagram of another example implementation of the programmable circuitry of FIG. 8.

FIG. 15 is a block diagram of an example software/firmware/instructions distribution platform (e.g., one or more servers) to distribute software, instructions, and/or firmware (e.g., corresponding to the example machine readable instructions of FIGS. 3-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Process control systems generally include controllers to perform routines, control strategies, and/or algorithms that manage field devices located in the control system. The field devices may be, for example, valves, pumps, fans, heaters, coolers, strippers, tanks, drums, coalescers, separators, reactors, compressors, motors, etc., and may perform process control functions (e.g., opening or closing valves) and measure process variables. In addition to managing field devices, controllers may generate process control information based on data received from the field devices. The process control information may include process statistics, alarms, monitoring information, process trend information, diagnostic information, field device status information, and/or messages from the field devices.

The controllers may transmit process control information to applications operating on workstations so that operators may manage the process control system. Additionally, process control systems may be configured and/or diagnosed from remote locations. For example, a customer in a first location may seek visibility into a process control system in a second location different from the first. Such example customers may access data associated with the process control system by sending requests to a server communicatively coupled to the process control system. However, customers may be limited to one-time requests for information from the process control system. Further, these one-time requests may not provide for client-specific and/or customizable requests for certain information from the process control system (e.g., information pertaining to the status of a device parameter on a field device).

Examples disclosed herein may be used to substantially continuously monitor device parameters in a process control system. That is, examples disclosed herein may continuously monitor device parameters and stream updated device parameter values over time to a requesting client device based on a single command/request/instruction from that client device without requiring the client device to re-request that device parameter multiple times.

Examples disclosed herein enable a client to describe and/or specify certain device parameters of one or more field devices in the process control system to monitor from a remote location (e.g., a location different from the process control system). For example, disclosed examples employ a JavaScript Object Notation (JSON) JSON file to include instructions in a client request (e.g., from a client device). Further, disclosed examples enable parameter monitor circuitry communicatively coupled to such a process control system to execute the JSON file and transmit the device parameter data back to the client (e.g., the client device). In examples disclosed herein, JSON is a human-readable programming language that can be used to define data structures to access data in a computing environment. JSON files provide efficiencies for developers to construct, read, and maintain so that developers can describe requested device parameter data. JSON files are also cost-efficient to deserialize.

Examples disclosed herein may be used to implement a data agent (e.g., a data server parameter monitor service (DataServerPMSvc)) to read and publish (1) time-sensitive process variable parameters periodically from multiple (e.g., hundreds, thousands, etc.) of field devices at the same time per specified device intervals, (2) time-insensitive process variable parameters per a schedule or device intervals longer than the device intervals of the time-sensitive process variable parameters, and (3) user-configurable configuration parameters when modified.

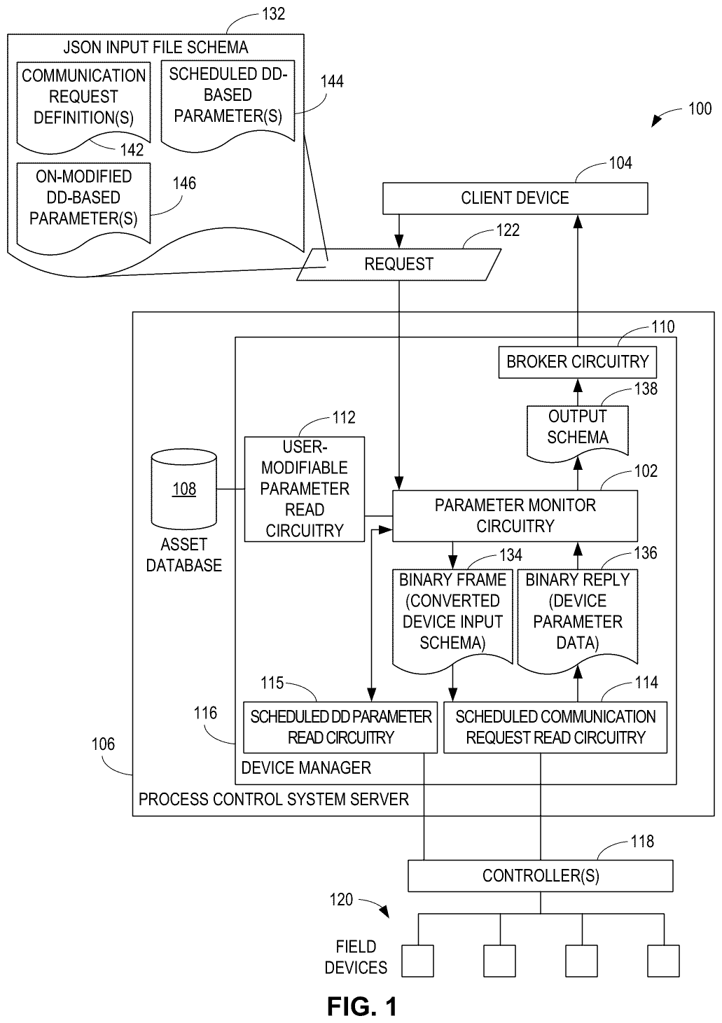

FIG. 1 is a block diagram of an example environment 100 in which example parameter monitor circuitry 102 operates to transmit device parameter data to an example client device 104. The environment 100 includes the example client device 104 in communication with an example process control system server 106. The example process control system server 106 includes the example parameter monitor circuitry 102, an example asset database 108, example broker circuitry 110, example user-modifiable parameter read circuitry 112, example scheduled communication request read circuitry 114, and example scheduled DD parameter read circuitry 115. In the example of FIG. 1, the parameter monitor circuitry 102, the broker circuitry 110, the user-modifiable parameter read circuitry 112, the scheduled communication request read circuitry 114, and the scheduled DD parameter read circuitry 115 are implemented in an example device manager 116. The environment 100 also includes one or more example field controller(s) 118 communicatively coupled with example field devices 120. The example field controller(s) 118 is/are communicatively coupled with the scheduled communication request read circuitry 114 and the scheduled DD parameter read circuitry 115 so that the parameter monitor circuitry 102 can communicate with the field devices 120 through the scheduled communication request read circuitry 114 and the field controller(s) 118 and/or through the scheduled DD parameter read circuitry 115 and the field controller(s) 118.

Although not shown, the process control system server 106 is also communicatively coupled to one or more of control modules, workstations, data storage, and/or other control devices located throughout a process control system. In some examples, the process control system server 106 may be communicatively coupled to multiple device networks (e.g., field device networks) having corresponding device network identifiers (IDs). In such examples, each device network includes one or more of the field devices 120. Information (e.g., measurement data, device parameter data, commands, requests, etc.) may be published to the example process control system server 106 by the field controller(s) 118, the field device(s) 120, computer device(s), etc. In some examples, commands to manage or calibrate one or more of the example field devices 120 may be published to the process control system server 106 by an example computer device (e.g., the client device 104). In other examples, the process control system server 106 may provide the client device 104 access to device parameter data from the field devices 120 and/or to data stored in the asset database 108 in response to an example request 122 from the client device 104.

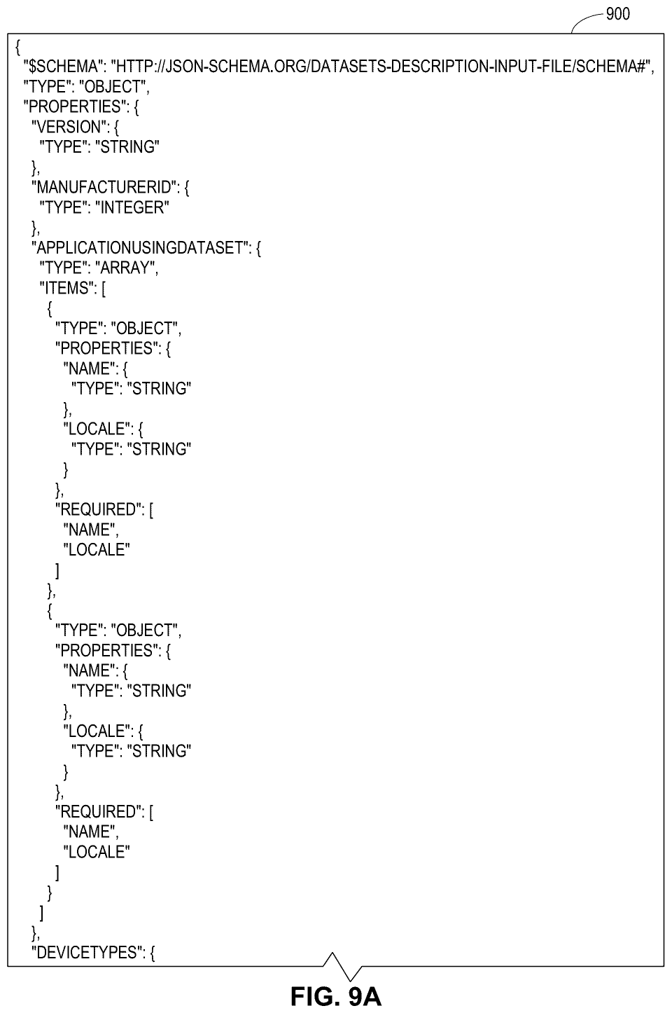

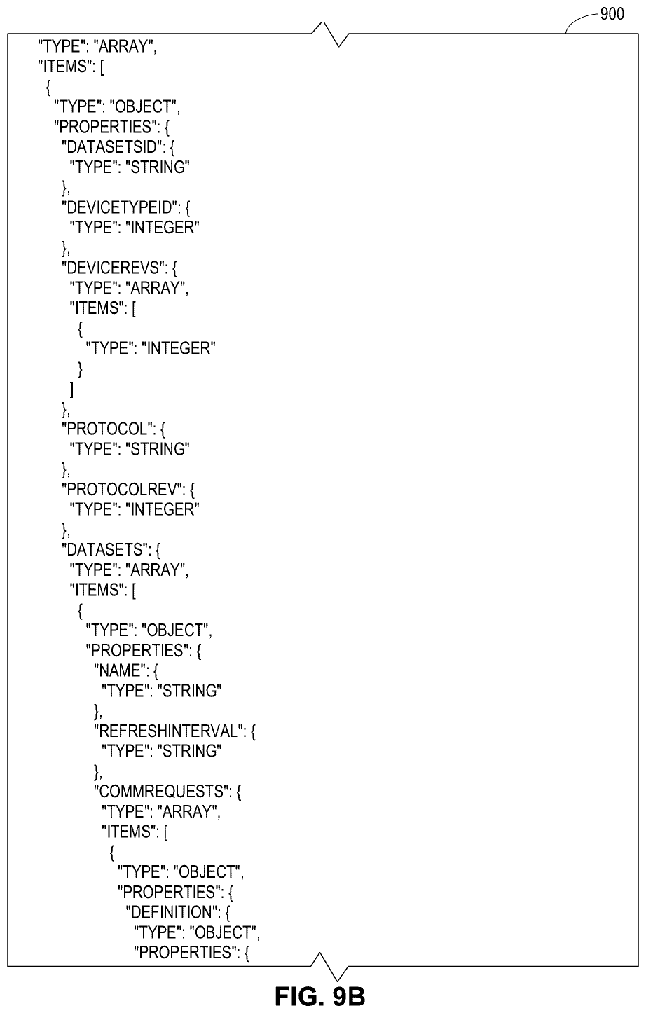

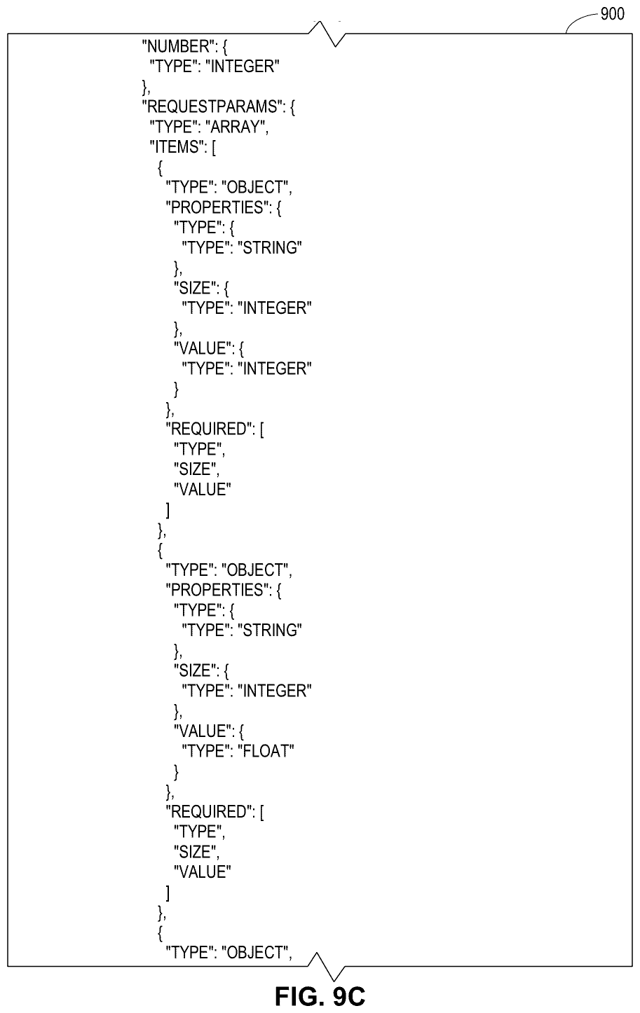

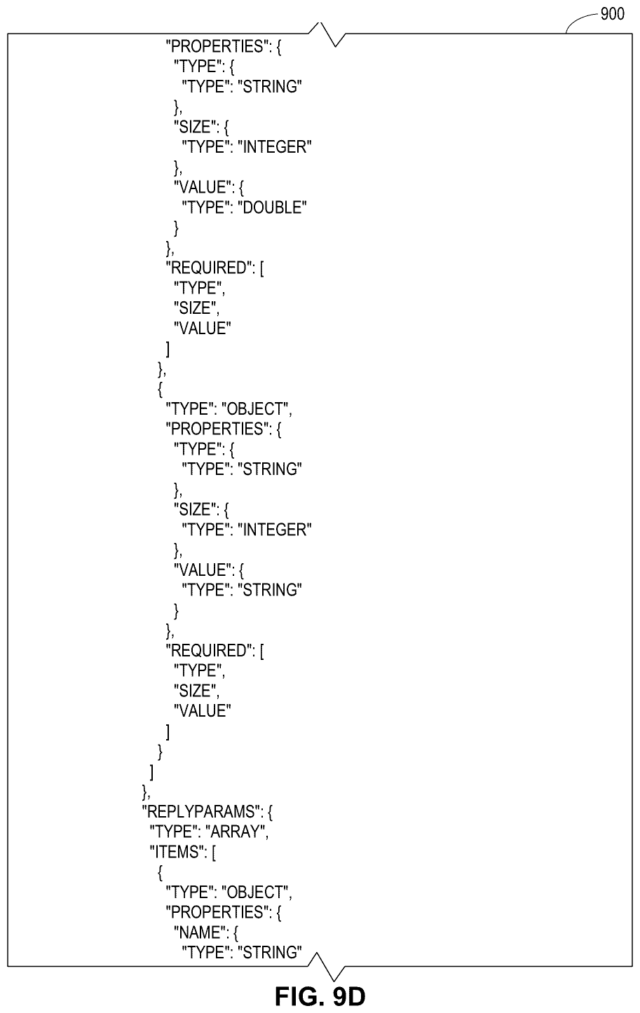

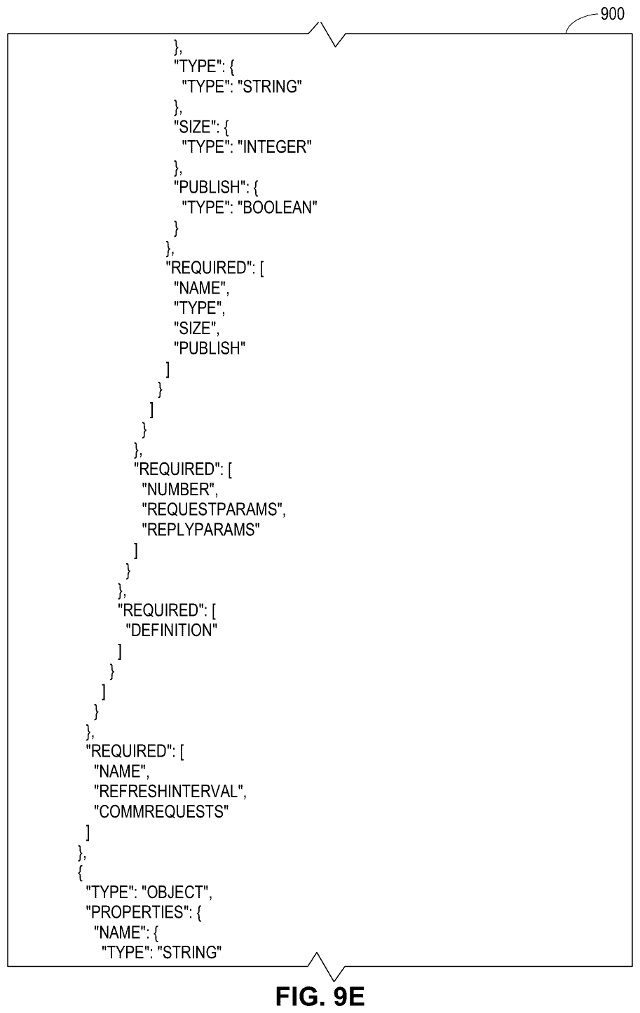

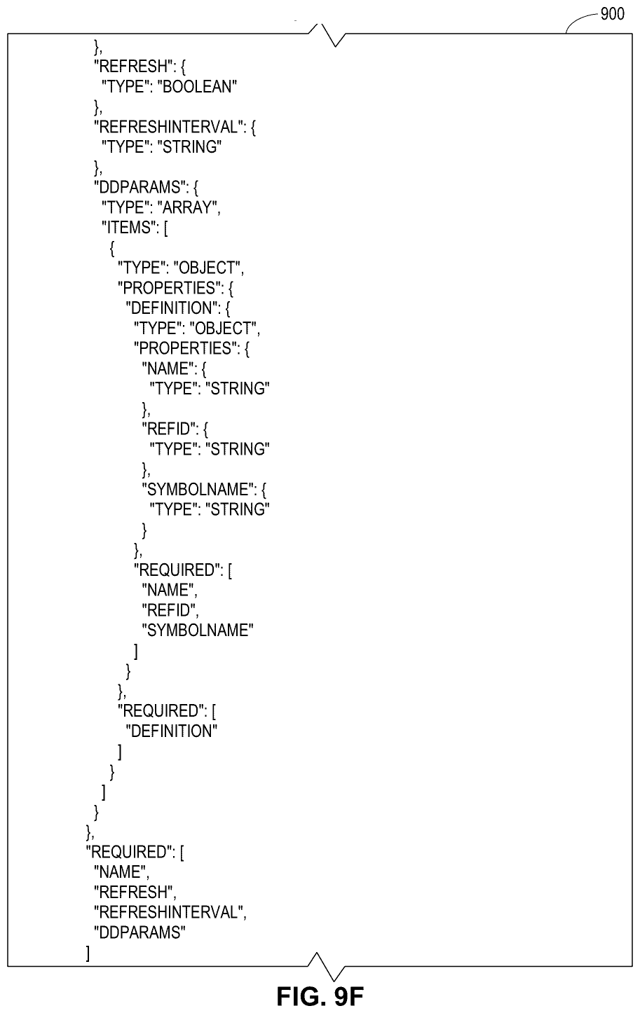

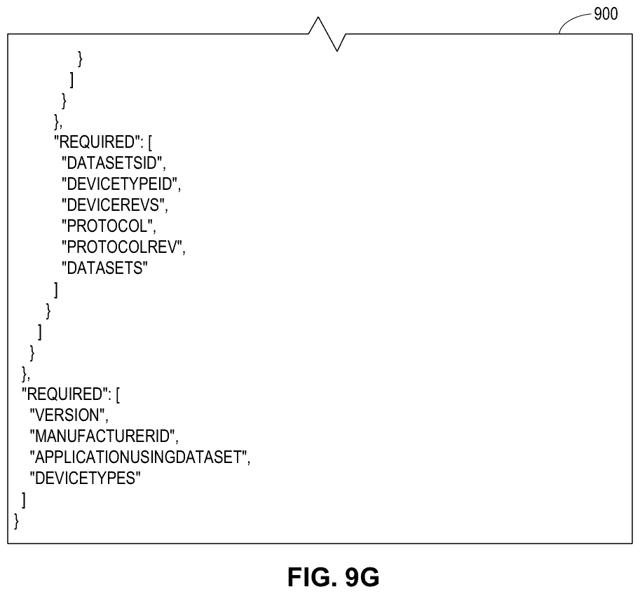

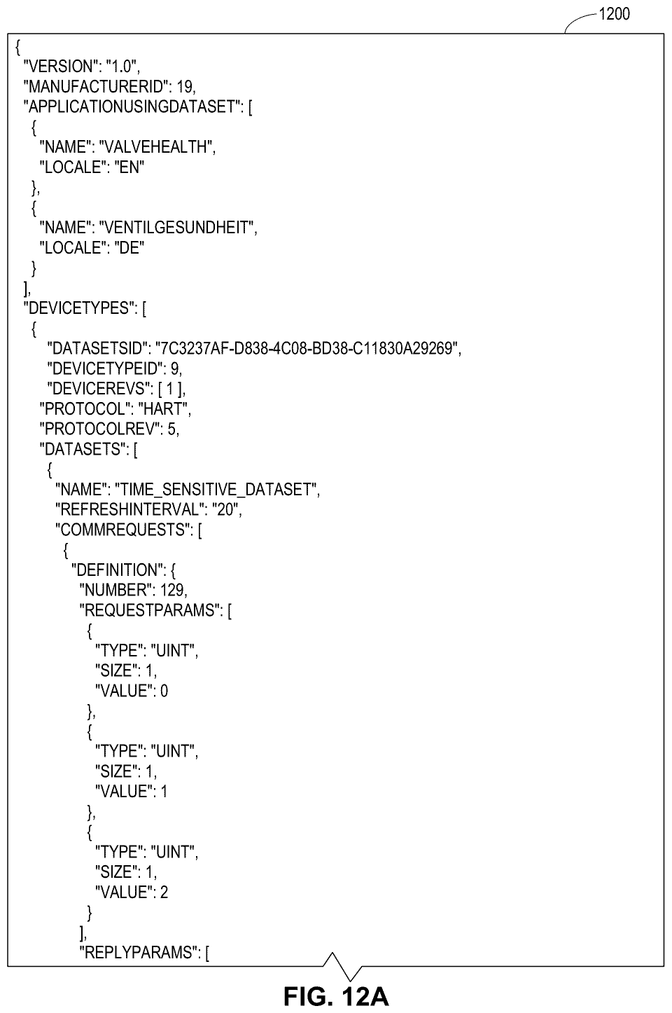

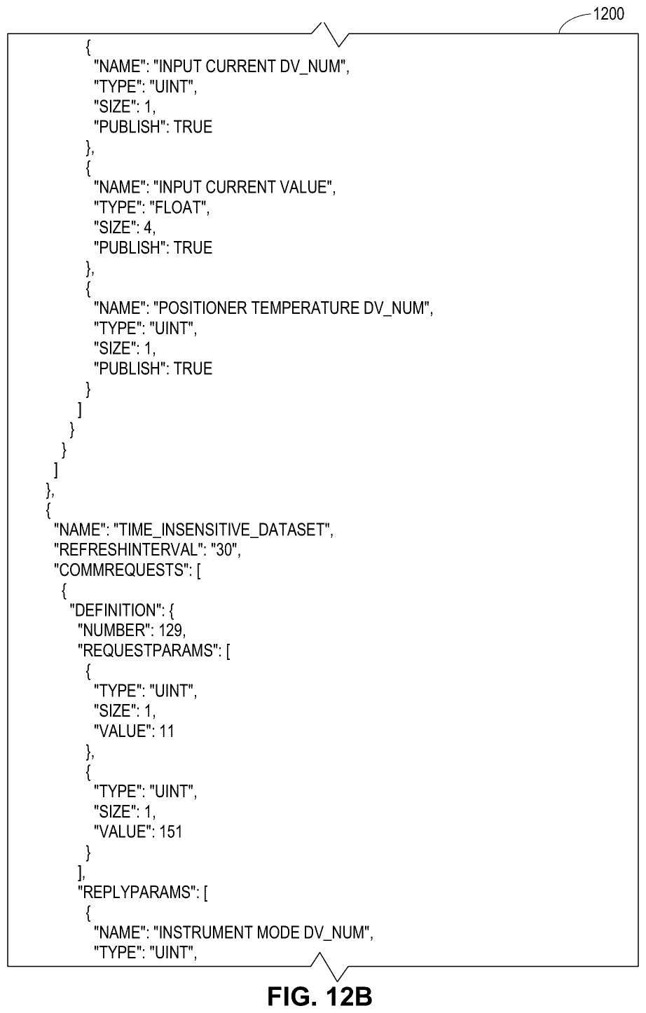

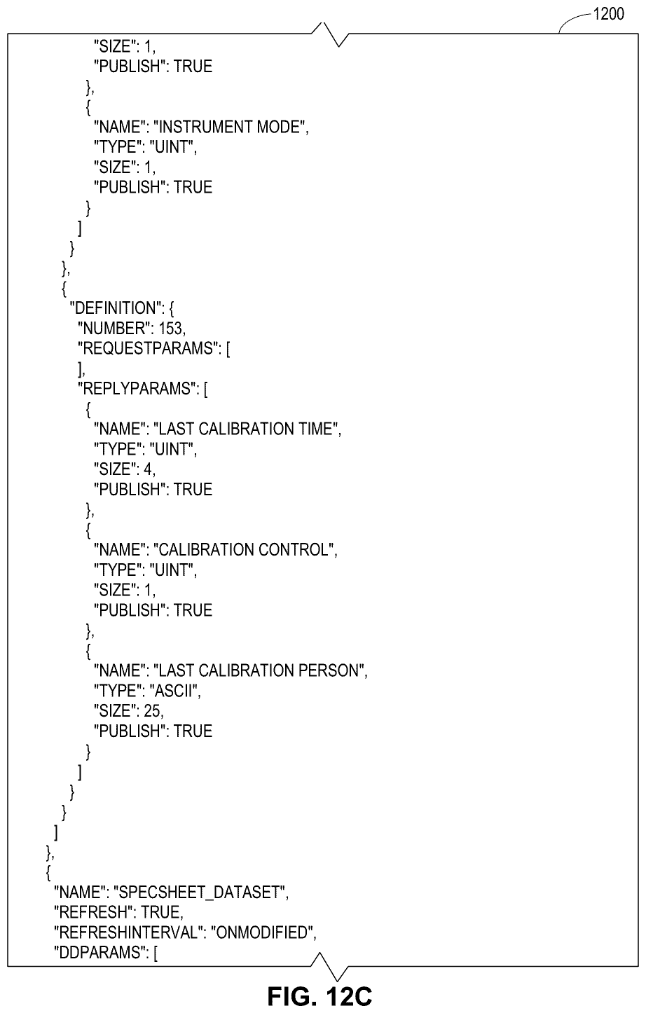

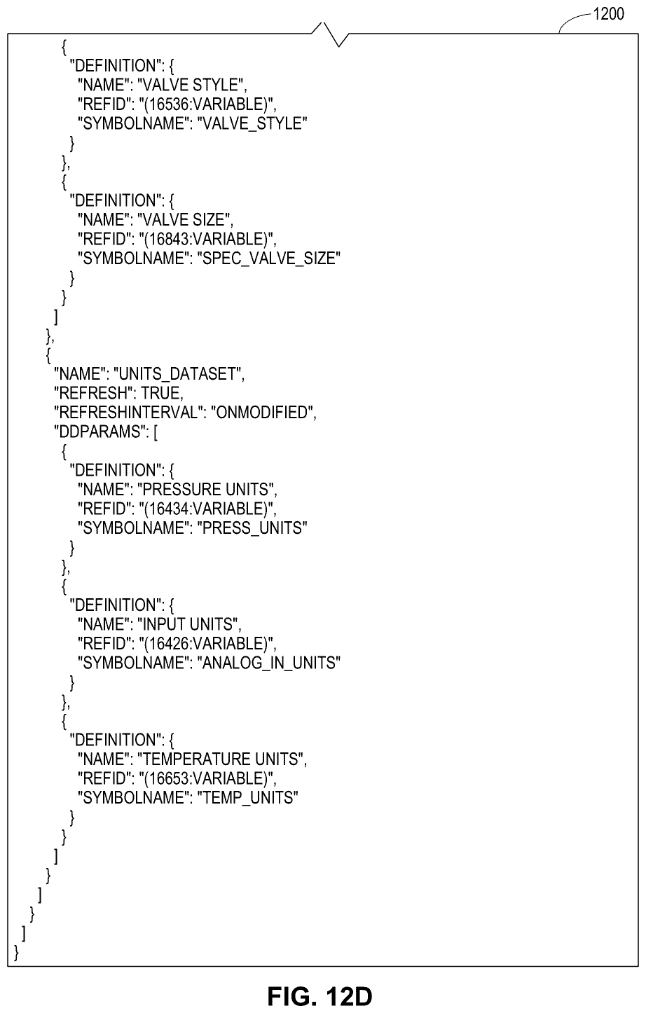

In the example of FIG. 1, the request 122 from the client device 104 includes an example JSON input file schema 132 and one or more request(s) to monitor (e.g., read, access, view, etc.) device parameter data associated with a process control system. In examples disclosed herein, the JSON input file schema 132 is in a human-readable format and may be created and edited via a program or application accessed by a user/developer via the client device 104. In examples disclosed herein, the JSON input file schema 132 implements a dataset description file or a parameter data description (PDD) file. The JSON input file schema 132 includes one or more commands (or instructions) and/or one or more parameter ID(s) to retrieve device parameter data from one or more specified field devices 120. Additionally or alternatively, the JSON input file schema 132 includes one or more commands (or instructions) and/or one or more parameter ID(s) to query the asset database 108 for device parameter data. An example JSON schema structure 900 that may be used to implement the JSON input file schema 132 is shown in FIGS. 9A-9G. FIGS. 12A-12D shows an example JSON input file 1200 having property values structured based on the example schema structure 900 of FIGS. 9A-9G. The JSON input file 1200 is an example implementation of the JSON input file schema 132.

As shown in FIG. 1, the JSON input file schema 132 includes one or more example communication request definition(s) 142, one or more example scheduled device description (DD)-based parameter(s) 144, and one or more example on-modified DD-based parameter(s) 146. In examples disclosed herein, the communication request definition(s) 142 includes one or more instruction(s) (or command(s)) to read one or more process variable(s) from one or more of the field devices 120 through the scheduled communication request read circuitry 114. In examples disclosed herein, the scheduled DD-based parameter(s) 144 include(s) one or more command(s) (or instruction(s)) to read one or more process variable(s) from one or more of the field devices 120 through the scheduled DD parameter read circuitry 115. For example, the command(s) of the scheduled DD-based parameter(s) 144 specify one or more parameter ID(s) of one or more process variable(s) to be read from the field device(s) 120. In examples disclosed herein, the on-modified DD-based parameter(s) 146 specify one or more parameter ID(s) of user-modifiable configuration parameters to be read from the asset database 108 through the user-modifiable parameter read circuitry 112. The user-modifiable configuration parameter data corresponds to device descriptions specified by a user/developer in the request 122.

In examples disclosed herein, the communication request definition(s) 142 may be used to read process variables from the field devices 120 as time-sensitive data and/or time-insensitive data. Also, in examples disclosed herein, the scheduled DD-based parameter(s) 144 may be used to read process variables from the field devices 120 as time-insensitive data. Also, in examples disclosed herein, the on-modified DD-based parameter(s) 146 may be used to read user-modifiable configuration parameters from the asset database 108 as time-insensitive data. In examples disclosed herein, time-sensitive data refers to data that is read based on an interval (e.g., a refresh interval) that is less than a threshold duration (e.g., less than three hours or some other duration). Also, in examples disclosed herein, time-insensitive data refers to data that is read based on an interval that is more than the threshold duration (e.g., more than three hours or some other duration).

In examples disclosed herein, the process control system server 106 executes Asset Management System (AMS) (e.g., Asset Management System developed by Emerson Electric Company of Ferguson, Missouri, United States of America). As used herein, AMS is a suite of computer programs designed to help organizations manage resources (e.g., the field devices 120, the controller(s) 118, computers, workstations, etc.) in a process control system. The device manager 116 is part of such an AMS. In examples disclosed herein, the device manager 116 is an AMS device manager service (e.g., Microsoft® Windows® service developed by Emerson Electric Company of Ferguson, Missouri, United States of America) that sends queries to the asset database 108 and raw command messages to the field devices 120.

The process control system server 106 is provided with the asset database 108 to store user-modifiable (or user-configurable) process control configuration parameters to configure resources of a process control system such as the process control system server 106, the device manager 116, the controller(s) 118, the field devices 120, etc. Values of the user-modifiable process control configuration parameters (e.g., user-modifiable configuration parameters) may be changed by a user/developer via a user-interface of a computer program accessed by the user/developer using the client device 104 (or any other connected client device). In examples disclosed herein, user-modifiable configuration parameter data may be referred to as “on-modified” parameter data and is categorized into an “on-modified” category. The “on-modified” category refers to the user-modifiable configuration parameter data that is read from the asset database 108 in response to detecting that it has been modified. The asset database 108 also stores monitored device lists that identify field devices, such as the field devices 120, that are configured and monitored in a process control system. The parameter monitor circuitry 102 can use such monitored device lists to identify the field devices 120 from which device parameters are to be read. In some examples, the asset database 108 is implemented by an AMS database that is also part of the AMS.

The device manager 116 is provided with the user-modifiable parameter read circuitry 112 to read user-modifiable configuration parameter data from the asset database 108 based on one or more parameter ID(s) specified in the on-modified DD-based parameter(s) 146 of the JSON input file schema 132. For example, the parameter monitor circuitry 102 is in communication with the user-modifiable parameter read circuitry 112 to access the asset database 108 via the user-modifiable parameter read circuitry 112. In the example of FIG. 1, the user-modifiable parameter read circuitry 112 implements an AMS Field Device Integration (FDI) Service (AmsFdiService). In examples disclosed herein, the AmsFdIService is a Microsoft® Windows® operating system (OS) service developed by the Emerson Electric Company of Ferguson, Missouri, United States of America. In other examples, the AmsFdIService may be implemented as a service from any other OS. The AmsFdiService forms queries for data to be retrieved from the asset database 108 based on one or more parameter ID(s) specified in the on-modified DD-based parameter(s) 146, parses replies from the asset database 108, and provides the requested information to the parameter monitor circuitry 102.

The device manager 116 is provided with the scheduled communication request read circuitry 114 to communicate with the field devices 120 to read process variable parameters of the field devices 120 based on instructions (or commands) in the communication request definitions 142 of the JSON input file schema 132. The device manager 116 is provided with the scheduled DD parameter read circuitry 115 to communicate with the field devices 120 to read process variable parameters of the field devices 120 based on commands in the scheduled DD-based parameters 144 of the JSON input file schema 132. Example process variables include status parameters and measurement parameters corresponding to the functions of the field devices 120. For example, status parameters include valve position or open/closed states (e.g., for a digital valve controller field device), mixing speed (e.g., for a mixer), etc. Example measurement parameters include temperature measurements (e.g., for a temperature sensor field device), pressure measurements (e.g., for a pressure sensor field device), flowrate (e.g., for a flow speed sensor field device), fluid level (e.g., for a fluid level sensor), etc.

In examples disclosed herein, the process variable parameters read by the scheduled communication request read circuitry 114 and/or the scheduled DD parameter read circuitry 115 from the field devices 120 are referred to as non-user-modifiable parameters because they are not modifiable by users but are instead generated by the field devices 120. The process variable parameters may additionally or alternatively be referred to as scheduled parameters because they are read from the field devices 120 at scheduled intervals or scheduled times (e.g., seconds, minutes, hours, etc.). In some examples, the non-user-modifiable parameters are also referred to as non-on-modifiable parameters because they are read from the field devices 120 based on specified schedules and not based on modification status. That is, a field device 120 may change its process variable value multiple times before a scheduled read of the process variable is initiated by the parameter monitor circuitry 102. In examples disclosed herein, process variable data read from the field devices 120 is categorized into a “non-on-modified” category.

In the example of FIG. 1, each of the scheduled communication request read circuitry 114 and the scheduled DD parameter read circuitry 115 implements a corresponding instance of an AMS Communication service (AmsCommService). In examples disclosed herein, the AmsCommService is a Microsoft® Windows® OS service developed by the Emerson Electric Company of Ferguson, Missouri, United States of America. In other examples, the AmsCommService may be implemented as a service from any other OS. The AmsCommService parses and interprets field device descriptions, forms field device commands, parses replies from the field devices 120, and caches field device parameter values.

In the example of FIG. 1, the broker circuitry 110 implements a Data Server Message Queueing Telemetry Transport (MQTT) Broker (DataServerMQTTBroker). In examples disclosed herein, the DataServerMQTTBroker is a component of the MQTT protocol that operates as a server to broker information between the client device 104 and the parameter monitor circuitry 102. In examples disclosed herein, MQTT refers to a publish-subscribe network protocol for message queuing service. For example, MQTT is a lightweight messaging protocol that is used to connect devices and applications over a network (e.g., a local area network (LAN), a wide area network (WAN), the Internet, etc.) in which subscriber devices subscribe to publisher devices (or services). A publisher device (or service) publishes information for access by ones of the subscriber devices subscribed to that publisher. An MQTT message payload is the content of a message to be published. An MQTT message topic is the title of the message under which the message is published using the MQTT protocol. For example, the broker circuitry 110 acts as an intermediary between the client device 104 (which is subscribed to messages from the broker circuitry 110) and the parameter monitor circuitry 102 that publishes user-modifiable configuration parameter data from the asset database 108 and/or process variable data from the field devices 120 for access by the client device 104 and/or any other interested client device. The broker circuitry 110 manages subscriptions and publications from connected devices and manages delivery of associated messages.

In the example of FIG. 1, the parameter monitor circuitry 102 implements a data server parameter monitor service (DataServerPMSvc) that retrieves requested device parameter data from the asset database 108 and/or from one or more of the field devices 120. The DataServerPMSvc may be programmed using any suitable programming language (e.g., C# with Microsoft Visual Studio) to publish communication request/command-based parameters. In examples disclosed herein, communication request-based parameter and command-based parameter are used interchangeably to refer to parameters that are accessed or monitored by the parameter monitor circuitry 102 based on requests, commands, and/or instructions received from a client device (e.g., the client device 104) in a request (e.g., the request 122). For example, the request 122 may specify one or more parameter(s) and/or include one or more command(s)/instruction(s) that cause(s) the parameter monitor circuitry 102 to retrieve requested device parameter data corresponding to the specified parameter(s) and/or command(s)/instruction(s). The parameter monitor circuitry 102 can then make the requested device parameter data available to the client device 104. In some examples, the DataServerPMSvc may be implemented as a service of an OS such as the Microsoft® Windows® OS or any other suitable OS.

Although the request 122 and the JSON input file schema 132 are shown as provided by the client device 104, in other examples, the process control system server 106 (or another server in communication with the process control system server 106) may generate the request 122 and the JSON input file schema 132. For example, the process control system server 106 (or another server) may run an application or program that is accessed remotely by a user/developer via the client device 104 (e.g., via a web interface or a client application). Based on such remote access, the user/developer can specify device parameter data in the JSON input file schema 132 that the parameter monitor circuitry 102 is to retrieve from the asset database 108 and/or the field device(s) 120.

As used herein, “device parameter data” or “data definition” refer to one or more of process control values, alarms, status information, diagnostic information, error messages, device identifiers, user-modifiable configuration parameters, process variable parameters associated with the example process control system. For example, the request 122 may indicate that the client device 104 requests access to a first device parameter (e.g., an alarm) associated with a first field device (e.g., a valve) in the process control system, a second device parameter (e.g., status information) associated with a second field device (e.g., a tank) in the process control system, etc. In some examples, the first device parameter and the second device parameter are different, unrelated, etc.

In the example of FIG. 1, the JSON input file schema 132 includes multiple commands (and/or instructions) and corresponding dataset definitions of multiple datasets of device parameter data to be monitored. Example datasets include: (1) time-sensitive datasets for process variable parameters periodically read from multiple (e.g., hundreds, thousands, etc.) of the field devices 120 concurrently per specified device intervals, (2) time-insensitive datasets for process variable parameters read from the field devices 120 per schedules or device intervals longer than the device intervals of the time-sensitive datasets, and (3) user-modifiable configuration datasets for user-modifiable configuration parameters read from the asset database 108. The multiple datasets can be associated with different ones of the field devices 120. Based on this information, the parameter monitor circuitry 102 can execute the multiple commands substantially concurrently (e.g., within 0.5 seconds of one another) to retrieve the requested device parameter data from one or more of the field devices 120 and/or the asset database 108.

In examples disclosed herein, based on the commands and/or instructions in the JSON input file schema 132, the parameter monitor circuitry 102 can continuously monitor the device parameter data specified in the JSON input file schema 132 over time. Based on this continuous monitoring, the parameter monitor circuitry 102 continuously sends or streams device parameter data values retrieved from the asset database 108 and/or the field devices 120 to the client device 104 without needing to receive multiple requests from the client device 104 for that device parameter data. As used herein, to stream data means to transmit or send data over a network connection (or other connection) as a continuous flow over time. As such, examples disclosed herein enable the client device 104 to send a single command in the JSON input file schema 132 via the request 122 to instruct the parameter monitor circuitry 102 to monitor one or more specified device parameters over time and continuously stream values for those one or more specified device parameters back to the client device 104. This allows the client device 104 to analyze changes in device parameter data values over time without needing to continuously send multiple requests (e.g., the request 122) for those device parameter data values. This reduces usage of network resources that would otherwise be employed to transmit multiple requests for the same device parameter data. This also reduces processor cycles of the client device 104 and the process control system server 106 that would otherwise be employed by the client device 104 to generate multiple requests for the same device parameter data and would otherwise be employed by the process control system server 106 to process the multiple requests.

In examples disclosed herein, the JSON input file schema 132 can include a command-based parameter dataset (e.g., a communication request-based parameter dataset based on the communication request definition(s) 142) and a device description (DD)-based parameter dataset (e.g., based on the scheduled DD-based parameter(s) 144 and/or the on-modified DD-based parameter(s) 146). The command-based parameter dataset (also referred to herein as a scheduled dataset) is used by the parameter monitor circuitry 102 (e.g., the DataServerPMSvc service) to read parameters from the field devices 120 in response to parameter read commands (or instructions) in the communication request definition(s) 142 of the request 122. In examples disclosed herein, after receiving the request 122 to read particular device parameter data from the field devices 120, the specified device parameter data are treated as time-sensitive parameters or time-insensitive parameters that are scheduled to be read periodically from one of or multiple (e.g., hundreds, thousands, etc.) ones of the field devices 120 per a request number and a set of request parameters specified in a dataset description file (e.g., the JSON input file schema 132). For example, the time-sensitive parameters are grouped in communication request/command-based time-sensitive parameter datasets (e.g., some of which are to be read at the same time) because they are identified in requests (e.g., the request 122) from client devices (e.g., the client device 104) as of interest for monitoring periodically according to a time-sensitive interval (e.g., an interval shorter than a threshold duration). Similarly, the time-insensitive parameters are grouped in communication request/command-based time-insensitive parameter datasets (e.g., some of which are to be read at the same time) because they are identified in requests (e.g., the request 122) from client devices (e.g., the client device 104) as of interest for monitoring periodically according to a time-insensitive interval (e.g., an interval longer than the threshold duration). The parameter monitor circuitry 102 can then stream the retrieved device parameter data from the field devices 120 to the requesting client device(s) (e.g., the client device 104).

In examples disclosed herein, the on-modified DD-based parameters 146 define an on-modified DD-based parameter dataset that is used by the parameter monitor circuitry 102 to read user-modifiable configuration parameter data from the asset database 108 in response to detecting that they have been modified. In examples disclosed herein, the scheduled DD-based parameters 144 define a scheduled DD-based parameter dataset that is used by the parameter monitor circuitry 102 to read process variables from the field devices 120 on a scheduled basis. In examples disclosed herein, a DD parameter describes what a field device 120 should do when reading from or writing to the field device 120 according to an FDI standard. A DD could define a pressure sensor field device, a temperature sensor field device, a level sensor field device, etc. A dataset description file that includes a plurality of DDs is registered with the FDI service to create interfaces for corresponding ones of the field devices 120.

In examples disclosed herein, the client device 104 can generate the JSON input file schema 132 to include definitions or properties that specify how to fetch the data and which parameter value(s) should be published. Example properties that may be defined in the JSON input file schema 132 include an ApplicationUsingDataset property, a UnitCodeMappings property, a DeviceTypes property, a Datasets property, a RequestParams property, and/or a DdParams property. In examples disclosed herein, the ApplicationUsingDataset property indicates which application consumes the datasets and is localizable. In examples disclosed herein, localizable means data can be formatted according to different end user preferences (e.g., language, time zone, units of measure, etc.).

In examples disclosed herein, the UnitCodeMappings property is part of a “units_dataset” and provides the mapping between “units code” and “units string” for a given field device manufacturer, which can be referenced by a communication reply parameter. In examples disclosed herein, the DeviceTypes property describes which field devices 120 can use the datasets defined in that property. In examples disclosed herein, the Datasets property specifies the datasets for a particular device type. A Datasets property includes the name of the dataset, a RequestParams property, and a DdParams property. The Dataset property also includes a RefreshInterval property or a read-only property. The RefreshInterval property indicates how often to read data from a field device and makes a dataset a “scheduled dataset” (e.g., a “non-on-modified” dataset, a non-user-modifiable dataset). In examples disclosed herein, a “scheduled dataset” could be a time-sensitive dataset or a time-insensitive dataset. The read-only property corresponds to a user-modifiable configuration parameter being read-only after the parameter is modified (e.g., by a user/developer via the client device 104) and makes the dataset an “on-modified” dataset (e.g., a user-modifiable dataset, a user-modifiable configuration parameter dataset).

In examples disclosed herein, the RequestParams property defines which communication requests/commands are used to retrieve device parameter data of a corresponding dataset. A request (e.g., the request 122) includes a request number, a sub-number, request parameters, and reply parameters. In examples disclosed herein, example properties for a request parameter include Type, Size, and Value. In examples disclosed herein, example properties for a reply parameter include Type, Size, UnitMapping, and Publish. In some examples, communication requests/commands specified in a dataset are defined using device descriptions (e.g., in the request 122). However, any other suitable format may be used to define communication requests/commands. In examples disclosed herein, the DdParams property defines which DD parameters are included in a dataset. In examples disclosed herein, a DD parameter includes a RefId property, which is the unique identifier of the DD parameter.

The parameter monitor circuitry 102 can access the request 122 and convert the JSON input file schema 132 to generate an example binary frame 134 (e.g., a converted device input schema). The binary frame 134 may be a file, executable code, etc. Through the conversion, the parameter monitor circuitry 102 reformats parameter data structures in the JSON input file schema 132 from a human-readable text format to a converted binary format in the binary frame 134 (e.g., a field device request) that is readable by the scheduled communication request read circuitry 114. The scheduled communication request read circuitry 114 uses the binary frame 134 to read device parameter data from the field devices 120 that the client device 104 identified in the JSON input file schema 132 as being of interest for monitoring.

In the example of FIG. 1, after the field devices 120 return requested device parameter data, the scheduled communication request read circuitry 114 generates an example binary reply 136 that includes the returned device parameter data. The parameter monitor circuitry 102 receives the binary reply 136 from the scheduled communication request read circuitry 114. In the illustrated example, the binary reply 136 includes raw binary data of values read from the field device(s) 120. The parameter monitor circuitry 102 converts the binary reply 136 from a binary format into a human-readable text format (e.g., JSON format) representing the requested device parameter data.

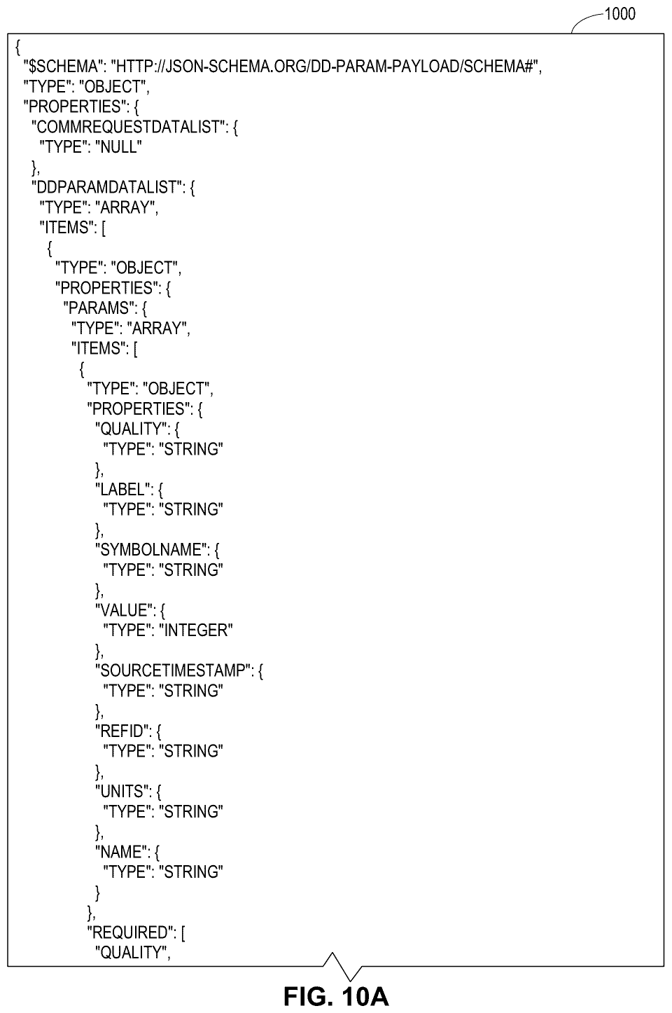

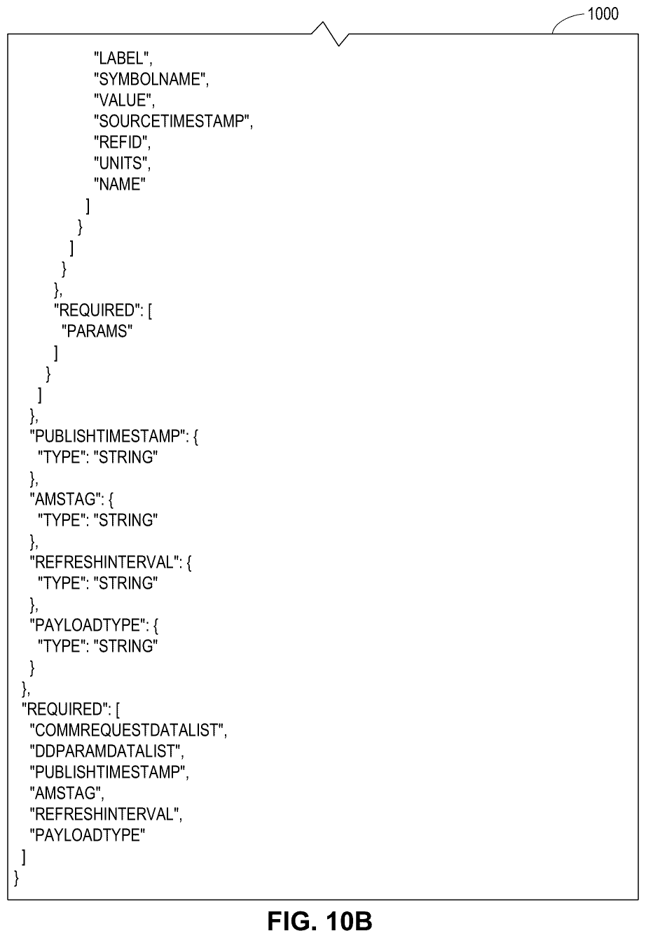

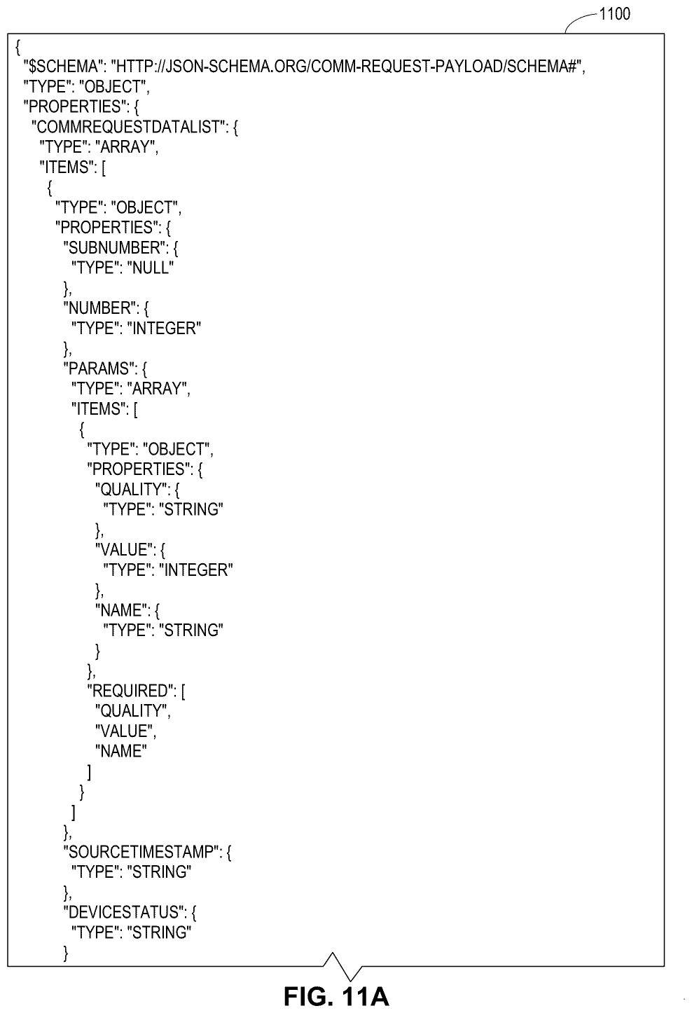

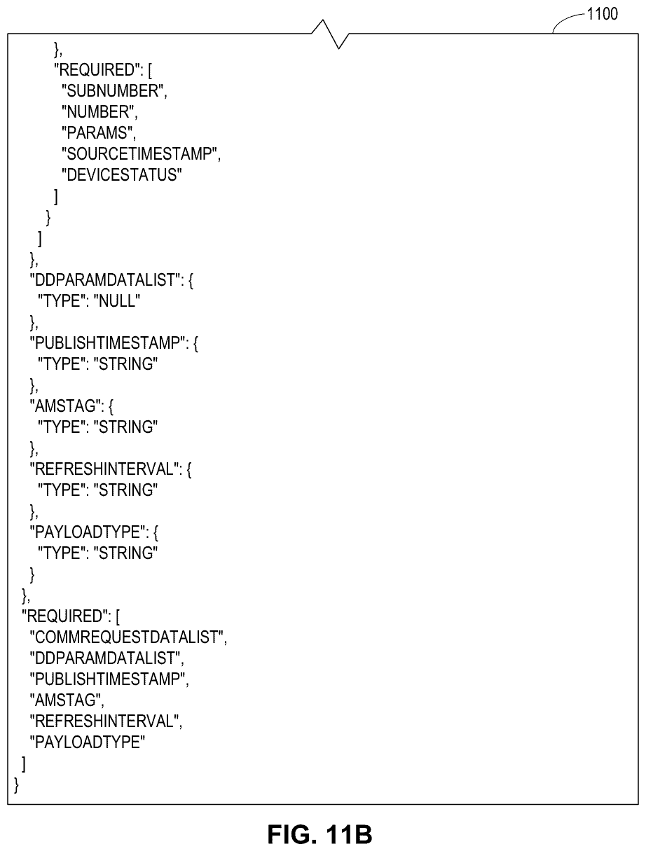

The parameter monitor circuitry 102 generates an example output schema 138 to include device parameter data in human-readable text. In the example of FIG. 1, the parameter monitor circuitry 102 generates the output schema 138 as a JSON file. Example schema structures 1000 and 1100 that may be used to implement the output schema 138 are shown in FIGS. 10A-10B and 11A-11B. The output schema 138 can include the device parameter data (e.g., the output) as time-sensitive parameters (e.g., a time-sensitive dataset payload), time-insensitive parameters (e.g., a time-insensitive dataset payload), and/or user-modifiable configuration parameters (e.g., a user-modifiable configuration parameters dataset payload). As described above, time-sensitive parameters include process variable parameter data retrieved by the parameter monitor circuitry 102 from the field devices 120 through the scheduled communication request read circuitry 114. As also described above, time-insensitive parameters include process variable parameter data retrieved by the parameter monitor circuitry 102 from the field devices 120 via the scheduled communication request read circuitry 114 and/or the scheduled DD parameter read circuitry 115. As also described above, the user-modifiable configuration parameters are retrieved by the parameter monitor circuitry 102 from the asset database 108 through the user-modifiable parameter read circuitry 112.

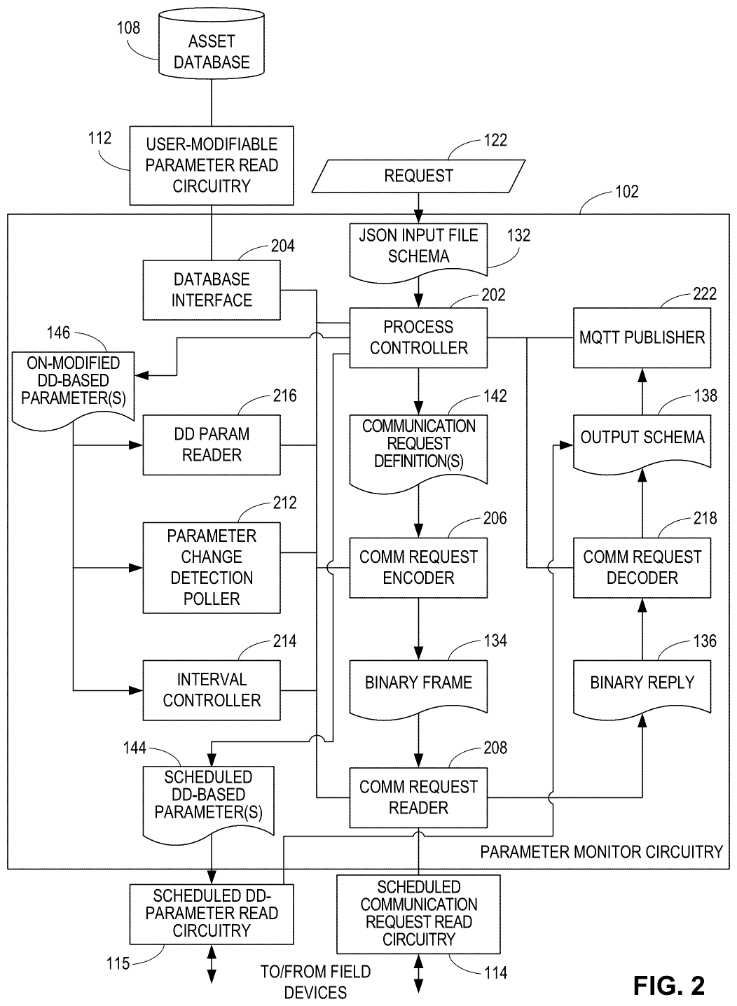

In some systems, a user is unable to monitor changes to many user-modifiable configuration parameters (e.g., editable parameters in on-modified datasets) concurrently on a single device network. Monitoring too many field devices concurrently in such systems (e.g., 1500 field devices or more) makes those systems consume too many resources including memory resources and processor resources. To overcome such challenges, examples disclosed herein employ a parameter change detection poller (the parameter change detection poller circuitry 212 of FIG. 2) to enable users to significantly increase the number of user-modifiable configuration parameters that can be monitored per minute without significantly increasing the amount of memory resources and processor resources that are used.

When a user modifies field device parameters, the device manger 116 in the process control system server 106 stores the new values in the asset database 108 with a timestamp. The parameter monitor circuitry 102 periodically polls the asset database 108 (e.g., through the parameter change detection poller circuitry 212 of FIG. 2) by giving a time range and a device network ID to get a list of modified user-modifiable configuration parameters. In examples disclosed herein, the list of modified user-modifiable configuration parameters include device field device tags, parameter IDs, timestamps of the modifications, etc. In some examples, the parameter monitor circuitry 102 can retrieve the label, units, and modified value of a user-modified configuration parameter by calling the user-modifiable parameter read circuitry 112 (e.g., an AmsFdiService) running on the process control system server 106. In examples disclosed herein, the polling frequency at which the parameter monitor circuitry 102 polls the asset database 108 (e.g., through the parameter change detection poller circuitry 212) is configurable. For example, a default value of 180 seconds can be used for the polling frequency in a process control system having 30,000 field devices.

Examples disclosed herein enable timely monitoring a large number of field devices (e.g., thousands of field devices) for scheduled datasets (e.g., process variable parameters that are accessed from the field devices 120 on a schedule basis) and on-modified datasets (e.g., user-modifiable configuration parameters that are accessed when modifications are detected). Examples disclosed herein can be used by the parameter monitor circuitry 102 to read different types of device parameter data including the reading of primary variables (PVs), secondary variables (SVs), tertiary variables (TVs), quaternary variables (FVs), and/or any other type of information corresponding to the field devices 120. In examples disclosed herein, the four types of variables PV, SV, TV, FV are process variables for multi-mode/variable field devices. Although some examples disclosed herein are described relative to reading process variable data, such examples can be used to read any other type of device parameter data.

In examples disclosed herein, the scheduled communication request read circuitry 114 (e.g., the AmsCommService) supports multiple calls in parallel and device host software (e.g., the DeltaV Distributed Control System developed by Emerson Electric Company of Ferguson, Missouri, United States of America; the PACSystems HART Multiplexer developed by Emerson Electric Company; etc.) running on the process control system server 106 supports concurrent requests for multiple field devices. As such, the parameter monitor circuitry 102 employs these capabilities of the scheduled communication request read circuitry 114 by sending multiple requests to the scheduled communication request read circuitry 114 per device network to read non-on-modified parameter datasets based on the communication request definition(s) 142.

The parameter monitor circuitry 102 uses the user-modifiable parameter read circuitry 112 (e.g., the AmsFdiService) and a structured query language (SQL) server (e.g., a Microsoft® SQL Server), which support concurrent calls, to retrieve modified user-modifiable configuration parameters (e.g., on-modified parameters) associated with the field devices 120 based on the on-modified DD-based parameter(s) 146. For example, the parameter monitor circuitry 102 can send multiple simultaneous reads (e.g., 40 or more simultaneous reads) to the user-modifiable parameter read circuitry 112 to fetch user-modifiable configuration parameters. As such, the parameter monitor circuitry 102 can be implemented to utilize the multiple-task advanced features of programming languages (e.g., the C# programming language or any other suitable programming language) to implement two parallel algorithms as noted above with a Task Parallel Library (TPL) Dataflow library. In examples disclosed herein, a TPL dataflow library is part of a TPL in the Microsoft® .NET Framework. The TPL Dataflow library is a set of data flow bock types that can be used to build applications. In examples disclosed herein, the parameter monitor circuitry 102 uses the TPL Dataflow library to build TPL dataflow producers and TPL dataflow consumers.

In examples disclosed herein, the parameter monitor circuitry 102 can use a multiple-task advanced feature in the C# programming language to implement parallel algorithms with the TPL Dataflow library. This helps achieve high performance on each AMS station (e.g., each instance of the user-modifiable parameter read circuitry 112 and the parameter monitor circuitry 102 that implement examples disclosed herein) by using as much device network bandwidth and throughput of the asset database 108 as is available.

In examples disclosed herein, the parameter monitor circuitry 102 selectively publishes datasets using the output schema 138 in the JSON format per the choice indicated in the dataset description file (e.g., the JSON input file schema 132) to the broker circuitry 110 (e.g., a DataServerMQTTBroker) for the client device 104 to consume. In examples disclosed herein, the parameter monitor circuitry 102 supports multiple field device communication protocols (e.g., HART, Fieldbus, etc.) to monitor multiple types of field devices based on a dataset description file (e.g., the JSON input file schema 132) provided by the client device 104 for the device type(s).

FIG. 2 is a block diagram of an example implementation of the parameter monitor circuitry 102 of FIG. 1 to transmit device parameter data. The example parameter monitor circuitry 102 includes example process controller circuitry 202, example database interface circuitry 204, example communication request encoder circuitry 206, example communication request reader circuitry 208, example parameter change detection poller circuitry 212, example interval controller circuitry 214, example device description (DD) parameter reader circuitry 216, example communication request decoder circuitry 218, and example MQTT publisher circuitry 222. The parameter monitor circuitry 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the parameter monitor circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example process controller circuitry 202 accesses the request 122. For example, the process controller circuitry 202 accesses the request 122 and obtains the JSON input file schema 132 from the request 122 to determine which device parameter data associated with one or more of the field devices 120 that the client device 104 (FIG. 1) has requested for monitoring. In some examples, the request 122 may indicate that the client device 104 (FIG. 1) is requesting access to at least one of a process control value, an alarm, status information, diagnostic information, an error message, configuration information, and/or a device identifier associated with at least one of the field devices 120 operating in the process control system. In the example of FIG. 2, the process controller circuitry 202 obtains the communication request definition(s) 142, the scheduled DD-based parameter(s) 144, and/or the on-modified DD-based parameter(s) 146 from the JSON input file schema 132. The process controller circuitry 202 provides the communication request definition(s) 142 to the communication request encoder circuitry 206 and provides the on-modified DD-based parameter(s) 146 to the parameter change detection poller circuitry 212, the interval controller circuitry 214, and the DD parameter reader circuitry 216.

To read process variables from the field devices 120 based on the scheduled DD-based parameters 144, the process controller circuitry 202 communicates with the scheduled DD parameter read circuitry 115 to request reads of requested process variables based on parameter IDs specified in the scheduled DD-based parameters 144. In response, the scheduled DD parameter read circuitry 115 reads the requested process variables from one or more of the field devices 120 based on a schedule that is defined by an interval specified in the JSON input file schema 132 in association with the scheduled DD-based parameters 144. The scheduled DD parameter read circuitry 115 returns the resulting process variable values from the field device(s) 120 to the output schema 138 so that the client device 104 can access the process variable values. In examples disclosed herein, the scheduled DD parameter read circuitry 115 can continually read the requested process variables per the specified schedule and continually stream the refreshed process variable values back to the client device 104 through the output schema 138.

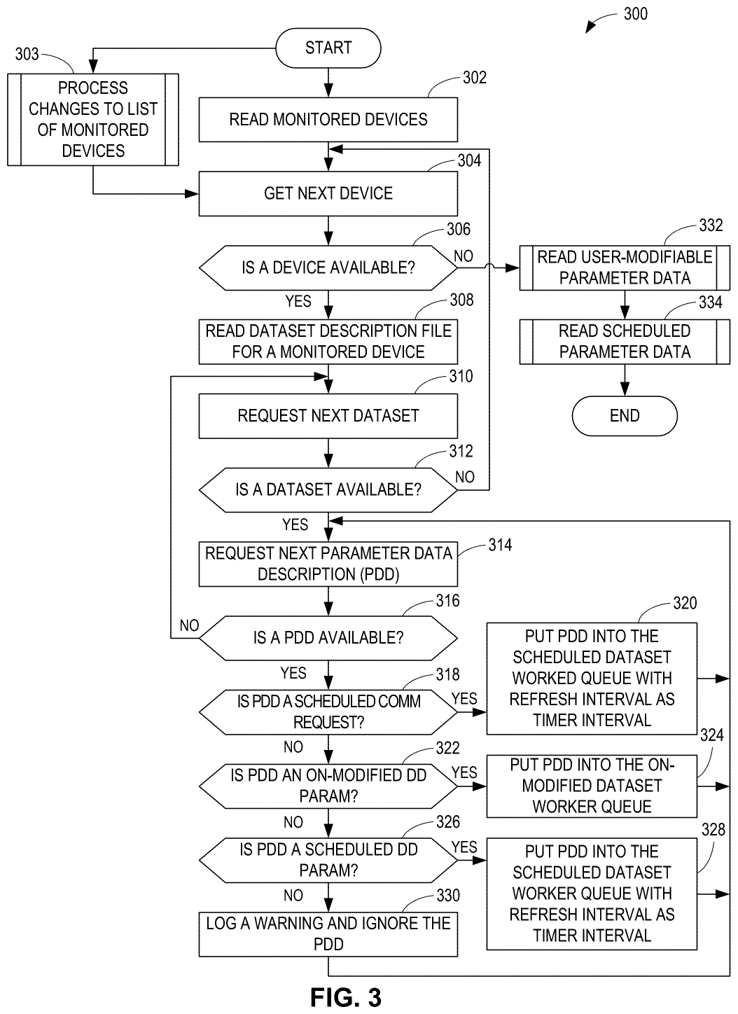

The process controller circuitry 202 also controls processes associated with the parameter monitor circuitry 102. For example, the process controller circuitry 202 can control processes associated with monitoring of changes to the field devices 120. In some examples, the process controller circuitry 202 controls the creation of Task Parallel Library (TPL) dataflow producers and TPL dataflow consumers. In examples disclosed herein, a TPL is a Microsoft® .NET Framework library designed for use in building scalable concurrent data processing pipelines. To utilize functionalities of such a TPL, the process controller circuitry 202 implements a TPL dataflow producer and a TPL dataflow consumer. The TPL dataflow producer is to supply tasks to the TPL dataflow consumer. For example, the TPL dataflow producer can identify user-modifiable configuration parameters in the asset database 108 that the TPL dataflow consumer is to check for changes. In some examples, the process controller circuitry 202 is instantiated by programmable circuitry executing access instructions and/or configured to perform operations such as those represented by the flowchart(s) of FIGS. 3-7.

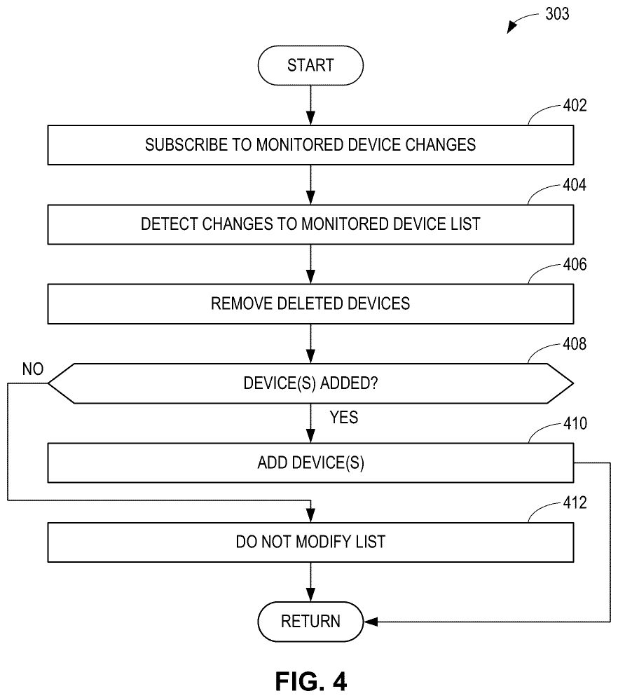

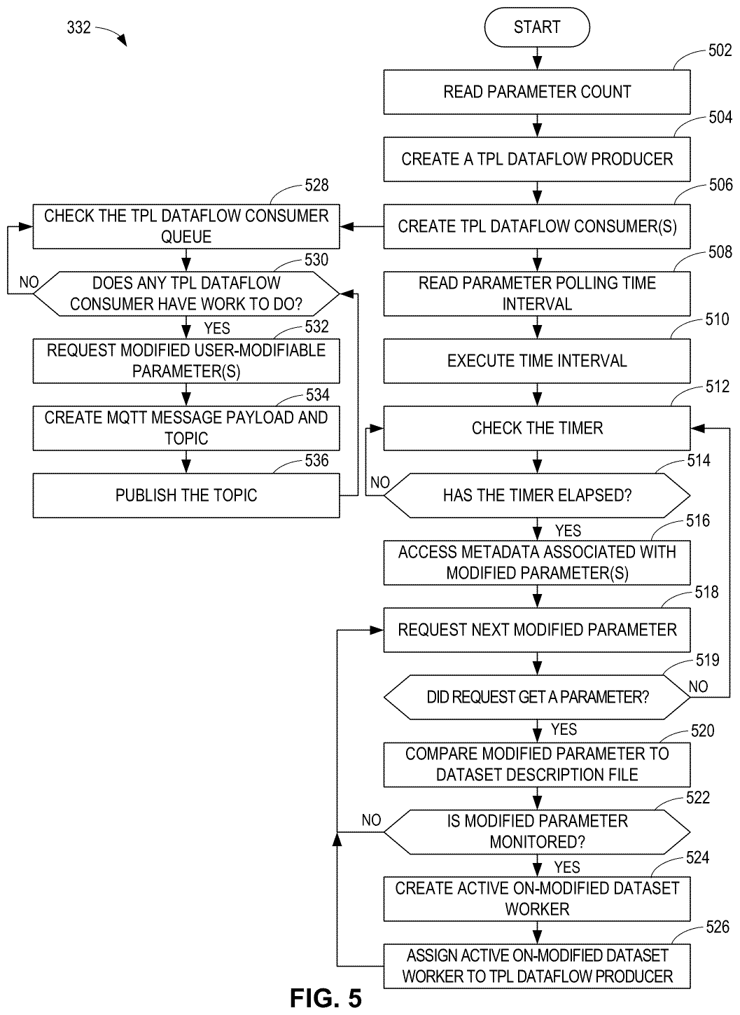

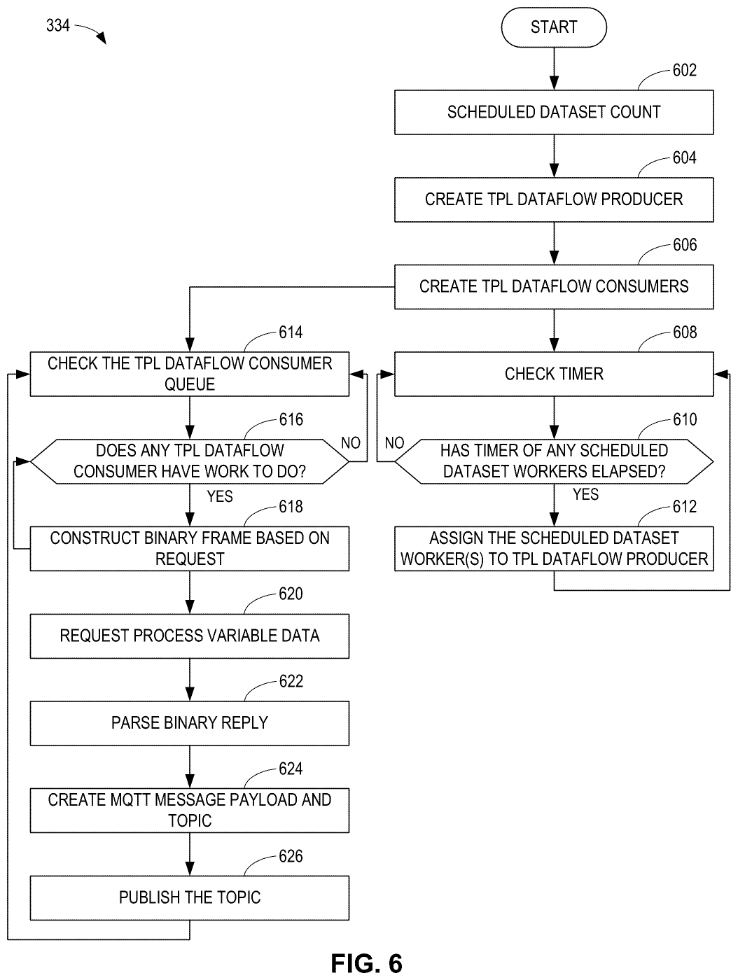

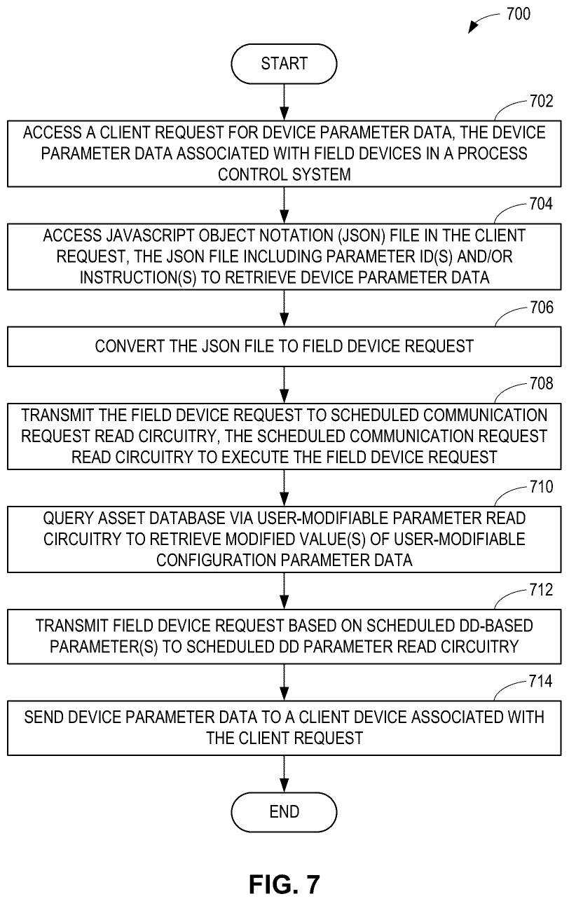

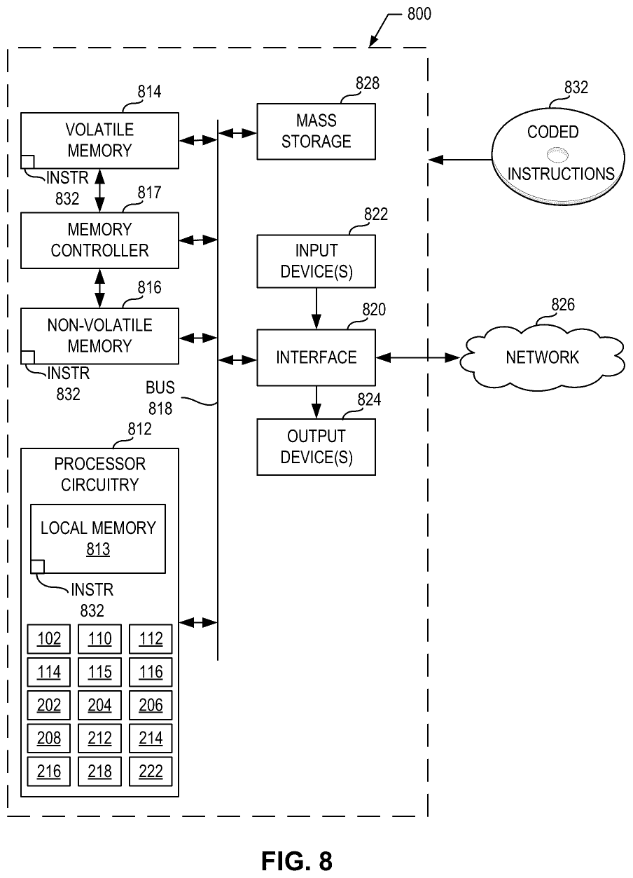

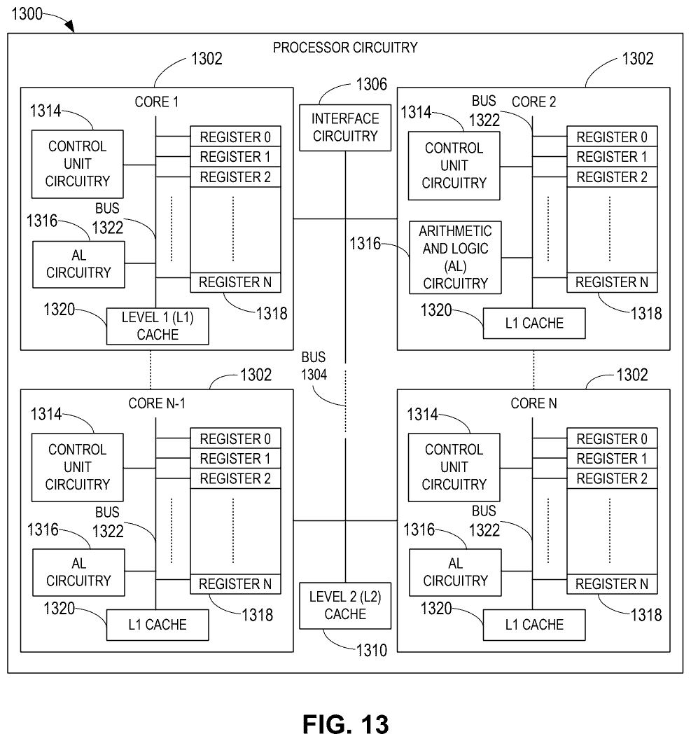

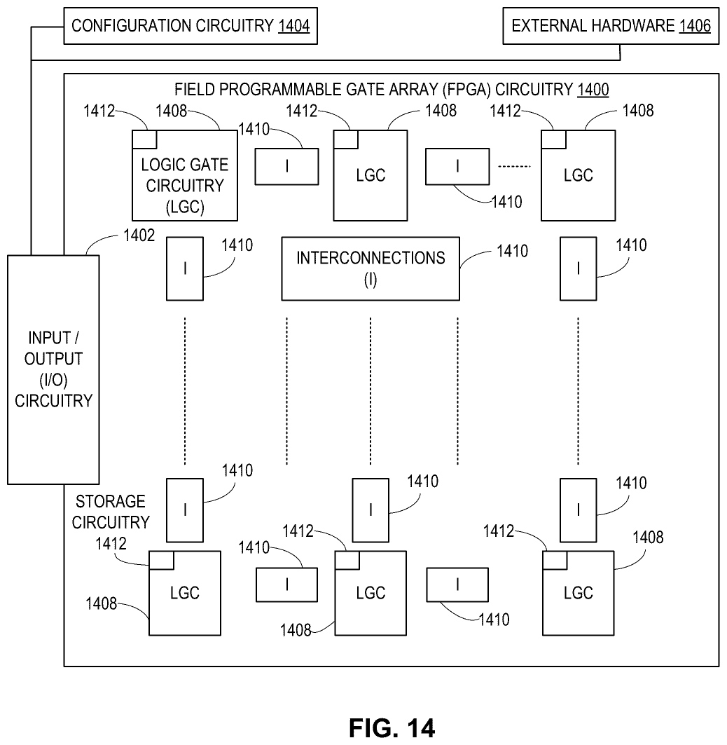

In some examples, the parameter monitor circuitry 102 includes means for controlling a process. For example, the means for controlling the process may be implemented by the process controller circuitry 202. In some examples, the process controller circuitry 202 may be instantiated by programmable circuitry such as the example programmable circuitry 812 of FIG. 8. For instance, the process controller circuitry 202 may be instantiated by the example microprocessor 1300 of FIG. 13 executing machine-executable instructions such as those implemented by at least blocks 302, 303, 304, 306, 308, 310, 312, 314, 316, 318, 320, 322, 324, 326, 328, and 330 of FIG. 3; blocks 402, 404, 406, 408, 410, and 412 of FIG. 4; blocks 502, 504, 506, 524, 526, 528, and 530 of FIG. 5; blocks 602, 604, 606, 612, 614, and 616 of FIG. 6; and blocks 702 and 704 of FIG. 7. In some examples, the process controller circuitry 202 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the process controller circuitry 202 may be instantiated by any other combination of hardware, software, and/or firmware. For example, the process controller circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The example communication request encoder circuitry 206 generates the binary frame 134 (e.g., a field device request) based on the communication request definition(s) 142. In examples disclosed herein, the communication request encoder circuitry 206 converts a definition of a requested field device parameter (e.g., in a RequestParams property of the communication request definition(s) 142) into the binary frame 134 that can be used to request data from the field devices 120. Such converting to the binary frame 134 significantly reduces complexity and maintainability of a JSON dataset description file (e.g., the JSON input file schema 132) and the amount of development time to create the file because JSON is a human-readable programming language. In some examples, the communication request encoder circuitry 206 is instantiated by programmable circuitry executing communication request encoder instructions and/or configured to perform operations such as those represented by the flowchart(s) of FIGS. 6 and 7.

In some examples, the parameter monitor circuitry 102 includes means for generating a binary frame. For example, the means for generating the binary frame may be implemented by the communication request encoder circuitry 206. In some examples, the communication request encoder circuitry 206 may be instantiated by programmable circuitry such as the example programmable circuitry 812 of FIG. 8. For instance, the communication request encoder circuitry 206 may be instantiated by the example microprocessor 1300 of FIG. 13 executing machine-executable instructions such as those implemented by at least block 618 of FIG. 6 and block 706 of FIG. 7. In some examples, the communication request encoder circuitry 206 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the communication request encoder circuitry 206 may be instantiated by any other combination of hardware, software, and/or firmware. For example, the communication request encoder circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The example communication request reader circuitry 208 reads device parameter data from one or more of the field devices 120 by sending the binary frame 134 to the scheduled communication request read circuitry 114. In addition, the communication request reader circuitry 208 receives the binary reply 136 from the scheduled communication request read circuitry 114. The binary reply 136 includes the requested device parameter data from one or more of the field devices 120. In some examples, the communication request reader circuitry 208 is instantiated by programmable circuitry executing communication request reader instructions and/or configured to perform operations such as those represented by the flowchart(s) of FIGS. 6 and 7.

In some examples, the parameter monitor circuitry 102 includes means for reading device parameter data from field devices. For example, the means for reading device parameter data from field devices may be implemented by the communication request reader circuitry 208. In some examples, the communication request reader circuitry 208 may be instantiated by programmable circuitry such as the example programmable circuitry 812 of FIG. 8. For instance, the communication request reader circuitry 208 may be instantiated by the example microprocessor circuitry 1300 of FIG. 13 executing machine executable instructions such as those implemented by at least block 620 of FIG. 6 and block 708 of FIG. 7. In some examples, the communication request reader circuitry 208 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the communication request reader circuitry 208 may be instantiated by any other combination of hardware, software, and/or firmware. For example, the communication request reader circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The communication request decoder circuitry 218 is provided to parse and decode the binary reply 136 returned by the field devices 120 and convert process variable values in the binary reply 136 from a binary format to a JSON format and write the JSON-based data into the output schema 138. For example, the communication request decoder circuitry 218 writes process variable values to the output schema 138 in a JSON format so that it is readable by a user/developer via the client device 104. In some examples, the communication request decoder circuitry 218 is instantiated by programmable circuitry executing communication request encoder instructions and/or configured to perform operations such as those represented by the flowchart of FIG. 6.

In some examples, the parameter monitor circuitry 102 includes means for decoding a binary reply. For example, the means for decoding the binary reply may be implemented by the communication request decoder circuitry 218. In some examples, the communication request decoder circuitry 218 may be instantiated by programmable circuitry such as the example programmable circuitry 812 of FIG. 8. For instance, the communication request decoder circuitry 218 may be instantiated by the example microprocessor 1300 of FIG. 13 executing machine executable instructions such as those implemented by at least block 622 of FIG. 6. In some examples, the communication request decoder circuitry 218 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the communication request decoder circuitry 218 may be instantiated by any other combination of hardware, software, and/or firmware. For example, the communication request decoder circuitry 218 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The database interface circuitry 204 is provided to communicate with the asset database 108 via the user-modifiable parameter read circuitry 112. In some examples, the database interface circuitry 204 is instantiated by programmable circuitry executing database interface instructions and/or configured to perform operations such as those represented by the flowchart(s) of FIGS. 3-7.

In some examples, the database interface circuitry 204 includes means for accessing a database. For example, the means for accessing a database may be implemented by the database interface circuitry 204. In some examples, the database interface circuitry 204 may be instantiated by programmable circuitry such as the example programmable circuitry 812 of FIG. 8. For instance, the database interface circuitry 204 may be instantiated by the example microprocessor 1300 of FIG. 13 executing machine executable instructions such as those implemented by one or more blocks of FIGS. 3-7. In some examples, the database interface circuitry 204 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the database interface circuitry 204 may be instantiated by any other combination of hardware, software, and/or firmware. For example, the database interface circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The DD parameter reader circuitry 216 reads device parameter data from the asset database 108 based on device descriptions in the on-modified DD-based parameter(s) 146. For example, the DD parameter reader circuitry 216 communicates with the user-modifiable parameter read circuitry 112 via the database interface circuitry 204 to access the device parameter data in the asset database 108. In some examples, the process controller circuitry 202 creates user-modifiable dataset work queues that include parameter data descriptions (PDDs) corresponding to device parameter data to be read by the DD parameter reader circuitry 216 from the asset database 108. In such examples, when a user-modifiable dataset worker queue (e.g., an on-modified dataset worker queue) includes a PDD, that user-modifiable dataset worker queue is referred to as having work for the DD parameter reader circuitry 216 to process. For example, a user-modifiable dataset worker queue includes tasks and corresponding metadata for user-modifiable configuration parameters (e.g., corresponding to ones of the field devices 120) that are to be monitored in the asset database 108 by corresponding TPL dataflow consumers. If a modified user-modifiable configuration parameter is not in a user-modifiable dataset worker queue, that user-modifiable configuration parameter is not to be monitored (e.g., values for that user-modifiable configuration parameter are not to be retrieved from the asset database 108). In some examples, the DD parameter reader circuitry 216 is instantiated by programmable circuitry executing DD parameter reader instructions and/or configured to perform operations such as those represented by the flowchart(s) of FIGS. 5 and 7.

In some examples, the parameter monitor circuitry 102 includes means for reading device parameter data based on device descriptions. For example, the means for reading device parameter data based on device descriptions may be implemented by the DD parameter reader circuitry 216. In some examples, the DD parameter reader circuitry 216 may be instantiated by programmable circuitry such as the example programmable circuitry 812 of FIG. 8. For instance, the DD parameter reader circuitry 216 may be instantiated by the example microprocessor 1300 of FIG. 13 executing machine executable instructions such as those implemented by at least blocks 518, 519, 520, 522, and 532 of FIG. 5 and block 710 of FIG. 7. In some examples, the DD parameter reader circuitry 216 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the DD parameter reader circuitry 216 may be instantiated by any other combination of hardware, software, and/or firmware. For example, the DD parameter reader circuitry 216 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The parameter change detection poller circuitry 212 is provided to poll the asset database 108 for changes made to user-modifiable configuration parameter data. For example, the parameter change detection poller circuitry 212 can query the asset database 108 periodically at user-specified intervals (and/or aperiodically) (e.g., user-specified intervals defined in the JSON input file schema 132 in association with the on-modified DD-based parameter(s) 146) for detected change(s) to user-modifiable configuration parameter data. During such polling, the parameter change detection poller circuitry 212 can determine when a user/developer has modified a user-modifiable configuration parameter in the asset database 108. In some examples, upon detecting that a change has been made to a user-modifiable configuration parameter, the parameter change detection poller circuitry 212 sends a request, notification, command, etc. to the DD parameter reader circuitry 216 to read the changed device parameter from the asset database 108.

The parameter change detection poller circuitry 212 may determine the occurrence of a change in the asset database 108 to add and/or remove ones of the field devices 120 to/from a process control system. In other examples, the parameter change detection poller circuitry 212 may detect a change (e.g., add, modify, alter, increase, decrease, remove, etc.) to a device parameter (e.g., a user-modifiable configuration parameter) associated with at least one of the field devices 120 in the device parameter data. In some examples, the parameter change detection poller circuitry 212 may detect multiple concurrent changes to the device parameter data. In some examples, the parameter change detection poller circuitry 212 may store instances of queries, detected change(s), etc. In some examples, these instances may include timestamps (e.g., day, time, etc.) associated with the change(s).

In some examples, the parameter change detection poller circuitry 212 may be implemented as a light-weight polling mechanism. In some examples, the parameter change detection poller circuitry 212 is instantiated by programmable circuitry executing parameter change detection poller instructions and/or configured to perform operations such as those represented by the flowchart of FIG. 5.

In some examples, the parameter monitor circuitry 102 includes means for polling. For example, the means for polling may be implemented by the parameter change detection poller circuitry 212. In some examples, the parameter change detection poller circuitry 212 may be instantiated by programmable circuitry such as the example programmable circuitry 812 of FIG. 8. For instance, the parameter change detection poller circuitry 212 may be instantiated by the example microprocessor 1300 of FIG. 13 executing machine executable instructions such as those implemented by at least block 516 of FIG. 5. In some examples, the parameter change detection poller circuitry 212 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the parameter change detection poller circuitry 212 may be instantiated by any other combination of hardware, software, and/or firmware. For example, the parameter change detection poller circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The interval controller circuitry 214 is provided to control an interval at which the parameter change detection poller circuitry 212 polls the asset database 108. For example, the interval controller circuitry 214 may receive a user-specified interval value from the process controller circuitry 202 that the process controller circuitry 202 obtains from the JSON input file schema 132 in association with the on-modified DD-based parameter(s) 146. In some examples, the interval controller circuitry 214 is instantiated by programmable circuitry executing interval controller instructions and/or configured to perform operations such as those represented by the flowchart(s) of FIGS. 5 and 6.

In some examples, the parameter monitor circuitry 102 includes means for controlling an interval. For example, the means for controlling an interval may be implemented by the interval controller circuitry 214. In some examples, the interval controller circuitry 214 may be instantiated by programmable circuitry such as the example programmable circuitry 812 of FIG. 8. For instance, the interval controller circuitry 214 may be instantiated by the example microprocessor 1300 of FIG. 13 executing machine executable instructions such as those implemented by at least blocks 508, 510, 512, and 514 of FIG. 5 and blocks 608 and 610 of FIG. 6. In some examples, the interval controller circuitry 214 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the interval controller circuitry 214 may be instantiated by any other combination of hardware, software, and/or firmware. For example, the interval controller circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The MQTT publisher circuitry 222 is provided to generate and send messages that include device parameter data from the user-modifiable parameter read circuitry 112, the scheduled communication request read circuitry 114, and/or the scheduled DD parameter read circuitry 115 to the broker circuitry 110 (FIG. 1). For example, the MQTT publisher circuitry 222 publishes user-modifiable configuration parameter data obtained from the asset database 108 via the user-modifiable parameter read circuitry 112 and/or non-user-modifiable parameter data (e.g., process variables) retrieved from one or more of the field devices 120 via the scheduled communication request read circuitry 114 and/or the scheduled DD parameter read circuitry 115. In the illustrated example, the MQTT publisher circuitry 222 obtains non-user-modifiable parameter data from the output schema 138. Publication from the MQTT publisher circuitry 222 to the broker circuitry 110 allows the broker circuitry 110 to, in turn, publish the information to one or more interested (e.g., subscribed) client devices such as the client device 104.

In examples disclosed herein, the MQTT publisher circuitry 222 publishes the device parameter data to the client device 104 based on execution of one or more commands in the JSON input file schema 132 in the parameter monitor circuitry 102. In some examples, the MQTT publisher circuitry 222 may substantially continuously (e.g., every few seconds) stream the device parameter data to the client device 104. In other words, the MQTT publisher circuitry 222 may automatically send updates to the client device 104 with refreshed device parameter data. For example, the MQTT publisher circuitry 222 may stream device parameter data from the asset database 108 based on changes to user-modifiable configuration parameter data in the asset database 108 and/or may stream device parameter data from one or more of the field devices 120 to the client device 104 based on scheduled reads of non-user-modifiable parameter data from the one or more field devices 120. In some examples, the MQTT publisher circuitry 222 is instantiated by programmable circuitry executing MQTT publisher instructions and/or configured to perform operations such as those represented by the flowchart(s) of FIGS. 5-7.

In some examples, the parameter monitor circuitry 102 includes means for publishing device parameter data. For example, the means for publishing device parameter data may be implemented by the MQTT publisher circuitry 222. In some examples, the MQTT publisher circuitry 222 may be instantiated by programmable circuitry such as the example programmable circuitry 812 of FIG. 8. For instance, the MQTT publisher circuitry 222 may be instantiated by the example microprocessor 1300 of FIG. 13 executing machine executable instructions such as those implemented by at least blocks 534 and 536 of FIG. 5; blocks 624 and 626 of FIG. 6; and block 714 of FIG. 7. In some examples, the MQTT publisher circuitry 222 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the MQTT publisher circuitry 222 may be instantiated by any other combination of hardware, software, and/or firmware. For example, the MQTT publisher circuitry 222 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the device manager 116 is illustrated in FIG. 1 and an example manner of implementing the parameter monitor circuitry 102 of FIG. 1 is illustrated in FIG. 2, one or more of the elements, processes, and/or devices illustrated in FIGS. 1 and 2 may be combined, divided, re-arranged, omitted, eliminated, and/or implemented in any other way. Further, the example parameter monitor circuitry 102, the example broker circuitry 110, the example user-modifiable parameter read circuitry 112, the example scheduled communication request read circuitry 114, and the scheduled DD parameter read circuitry 115, and/or, more generally, the example device manager 116, and/or the example process controller circuitry 202, the example database interface circuitry 204, the example communication request encoder circuitry 206, the example communication request reader circuitry 208, the example parameter change detection poller circuitry 212, the example interval controller circuitry 214, the example DD parameter reader circuitry 216, the example communication request decoder circuitry 218, and the example MQTT publisher circuitry 222, and/or, more generally, the example parameter monitor circuitry 102 of FIG. 2, may be implemented by hardware alone or by hardware in combination with software and/or firmware. Thus, for example, any of the example parameter monitor circuitry 102, the example broker circuitry 110, the example user-modifiable parameter read circuitry 112, the example scheduled communication request read circuitry 114, and the scheduled DD parameter read circuitry 115, and/or, more generally, the example device manager 116, and/or the example process controller circuitry 202, the example database interface circuitry 204, the example communication request encoder circuitry 206, the example communication request reader circuitry 208, the example parameter change detection poller circuitry 212, the example interval controller circuitry 214, the example DD parameter reader circuitry 216, the example communication request decoder circuitry 218, and the example MQTT publisher circuitry 222, and/or, more generally, the example parameter monitor circuitry 102, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the device manager 116 of FIG. 1 and/or the example parameter monitor circuitry 102 of FIG. 2 may include one or more elements, processes, and/or devices in addition to, or instead of, those illustrated in FIG. 1 and/or FIG. 2, and/or may include more than one of any or all of the illustrated elements, processes and devices.

Flowcharts representative of example machine-readable instructions, which may be executed by programmable circuitry to implement and/or instantiate the device manager 116 of FIG. 1 and/or the parameter monitor circuitry 102 of FIG. 2 and/or representative of example operations which may be performed by programmable circuitry to implement and/or instantiate the device manager 116 of FIG. 1 and/or the parameter monitor circuitry 102 of FIG. 2, are shown in FIGS. 3-7. The machine-readable instructions may be one or more executable programs or portion(s) of one or more executable programs for execution by programmable circuitry such as the programmable circuitry 812 shown in the example programmable circuitry platform 800 discussed below in connection with FIG. 8 and/or may be one or more function(s) or portion(s) of functions to be performed by the example programmable circuitry (e.g., an FPGA) discussed below in connection with FIGS. 13 and/or 14. In some examples, the machine-readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program(s) is/are described with reference to the flowcharts illustrated in FIGS. 3-7, many other methods of implementing the device manager 116 and/or the example parameter monitor circuitry 102 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-7 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 3 is a flowchart representative of example machine-readable instructions and/or example operations 300 that may be executed, instantiated, and/or performed by programmable circuitry to process an example input file that specifies device parameter data to be monitored. The example machine-readable instructions and/or the example operations 300 of FIG. 3 begin at blocks 302 and 303 which may be performed concurrently. At block 302, the process controller circuitry 202 reads a list of monitored devices from the asset database 108. The list of monitored devices identifies configured (e.g., active, enabled, allocated, etc.) ones of the field devices 120 in a process control system and that are to be monitored. For example, the process controller circuitry 202 can request the list of monitored devices from the asset database 108 via the database interface circuitry 204. The list of monitored devices may be generated and/or selected by a user/developer via the client device 104 and stored as a file in storage space, for example. At block 303, the process controller circuitry 202 processes changes to the list of monitored devices. For example, the process controller circuitry 202 determines whether a user/developer has removed or added any field devices (e.g., the field devices 120) from/to the list of monitored devices. Example instructions and/or operations that may be used to implement block 303 are described below in connection with FIG. 4.

At block 304, the process controller circuitry 202 requests a next device from the list of monitored devices. For example, the process controller circuitry 202 can use a “GET” command to request a device identifier or a tag identifier of the next field device from the list of monitored devices.

At block 306, the process controller circuitry 202 determines whether a next device is available. For example, a next field device 120 is available in the list of monitored devices until all of the monitored field devices 120 in the list of monitored devices have been processed by the example instructions and/or operations 300 of FIG. 3. If the request of block 304 results in a null or empty value (e.g., there is not another monitored field device to process), the process controller circuitry 202 determines at block 306 that a next device is not available in the list of monitored devices. Otherwise, if the request of block 304 results in a device identifier or a tag identifier of one of the field devices 120, the process controller circuitry 202 determines at block 306 that a next device is available.

If the process controller circuitry 202 determines a next device is available (block 306: YES), the process controller circuitry 202 reads a dataset description file for the selected monitored device (block 308). For example, the process controller circuitry 202 reads a dataset description file (e.g., the JSON input file schema 132) corresponding to the device identifier or tag identifier received at block 304. In the illustrated example, the process controller circuitry 202 can access the dataset description file from the client device 104 to obtain parameter names (or parameter data descriptions (PDDs)) of device parameters of the selected monitored device that are specified by a user/developer as of interest for monitoring.

At block 310, the process controller circuitry 202 requests a next dataset. For example, the process controller circuitry 202 can use a “GET” command to request the next dataset from the dataset description file. In the illustrated example, a dataset refers to a time-sensitive dataset, a time-insensitive dataset, and/or a user-modifiable configuration parameters dataset. In the example of FIG. 3, a time-sensitive dataset corresponds to device parameter data requested via the communication request definition(s) 142, a time-insensitive dataset corresponds to device parameter data requested via the communication request definition(s) 142 and/or the scheduled DD-based parameter(s) 144, and a user-modifiable configuration parameters dataset corresponds to device parameter data requested via the on-modified DD-based parameter(s) 146. Each iteration through block 310 gets a different one of the available datasets to identify device parameters in each dataset to read from the asset database 108 and/or from the field device(s) 120. Additionally or alternatively, device parameters to retrieve may be grouped in other datasets such as a specsheet dataset, and/or a units dataset. In examples disclosed herein, a specsheet dataset defines specification sheet characteristics of a field device and a units dataset defines measurement units in which values are returned from a field device. At block 312, the process controller circuitry 202 determines whether a dataset is available. For example, if the request of block 310 results in a null or empty value, the process controller circuitry 202 determines at block 312 that a next dataset is not available in the dataset description file. Otherwise, if the request of block 310 results in a dataset, the process controller circuitry 202 determines at block 312 that a next dataset is available.

If the process controller circuitry 202 determines that a next dataset is not available (block 312: NO), control returns to block 304. Otherwise, if the process controller circuitry 202 determines that a next dataset is available (block 312: YES), the process controller circuitry 202 requests a next parameter data description (PDD) (block 314). For example, the process controller circuitry 202 can use a “GET” command to request the next PDD from the dataset obtained at block 310. At block 316, the process controller circuitry 202 determines whether a next PDD is available. In the illustrated example, a PDD defines the device parameter data that is to be read, monitored, etc. For example, the PDD may define a user-modifiable configuration parameter (e.g., on-modified data) available in the asset database 108 or a process variable (e.g., scheduled data) accessible from one of the field devices 120. If the request of block 314 results in a null or empty value, the process controller circuitry 202 determines at block 316 that a next PDD is not available in the dataset. Otherwise, if the request of block 316 results in a PDD, the process controller circuitry 202 determines at block 316 that a next PDD is available.

If the process controller circuitry 202 determines that a next PDD is not available (block 316: NO), control returns to block 310. Otherwise, if the process controller circuitry 202 determines that a next PDD is available (block 316: YES), the process controller circuitry 202 determines whether the PDD defines a scheduled communication request (block 318). For example, the process controller circuitry 202 can determine that the PDD defines a scheduled communication request based on a type property of a RequestParams property of the dataset obtained at block 310. In the example of FIG. 3, the process controller circuitry 202 determines that the PDD defines a scheduled communication request at block 318 if the PDD is from the communication request definition(s) 142. In examples disclosed herein, scheduled communication requests are commands used to read time-sensitive and/or time-insensitive scheduled parameter data (e.g., process variable parameter data, non-user-modifiable parameter data, etc.) from corresponding ones of the field devices 120. If the process controller circuitry 202 determines that the PDD of block 314 defines a scheduled communication request (block 318: YES), the process controller circuitry 202 puts the PDD into a scheduled dataset worker queue with a corresponding refresh interval as the timer interval for that scheduled dataset worker queue (block 320). In examples disclosed herein, the refresh interval value is a customer-specific value that can be specified by a user/developer in the dataset obtained at block 310. For example, the process controller circuitry 202 can obtain the refresh interval value (e.g., seconds, minutes, hours, etc.) from a RefreshInterval property of the dataset obtained at block 310. In some examples, the refresh interval value may be short such as multiple seconds, one second, or less. In other examples, the refresh interval value may be longer such as one minute, 15 minutes, one hour, or more.

If the process controller circuitry 202 determines that the PDD of block 314 does not define a scheduled communication request (block 318: NO), the process controller circuitry 202 determines whether the PDD defines an on-modified DD parameter (e.g., a user-modifiable configuration parameter) (block 322). For example, the process controller circuitry 202 can determine whether the PDD defines a user-modifiable configuration parameter based on the type property of the RequestParams property of the dataset obtained at block 310. In the example of FIG. 3, the process controller circuitry 202 determines that the PDD defines a user-modifiable configuration parameter at block 322 if the PDD is from the on-modified DD-based parameter(s) 146. As described above, a user-modifiable configuration parameter is modifiable by a user/developer to configure resources of a process control system such as the process control system server 106, the device manager 116, the controller(s) 118, the field devices 120, etc.

If the process controller circuitry 202 determines that the PDD defines an on-modified DD parameter (e.g., a user-modifiable configuration parameter) (block 322: YES), the process controller circuitry 202 puts the PDD into an on-modified dataset worker queue (e.g., a user-modifiable dataset worker queue) (block 324). For example, the user-modifiable dataset work queue is processed by the DD parameter reader circuitry 216 to read the device parameter data identified by the PDD user-modifiable dataset work queue from the asset database 108 via the database interface circuitry 204 and the user-modifiable parameter read circuitry 112.

If the process controller circuitry 202 determines that the PDD does not define a user-modifiable configuration parameter (block 322: NO), the process controller circuitry 202 determines whether the PDD defines a scheduled DD parameter (block 326). For example, the process controller circuitry 202 can determine whether the PDD defines a scheduled DD parameter based on the type property of the RequestParams property of the dataset obtained at block 310. In the example of FIG. 3, the process controller circuitry 202 determines that the PDD defines a scheduled DD parameter at block 326 if the PDD is from the scheduled DD-based parameter(s) 144. In examples disclosed herein, a scheduled DD parameter is used to read time-insensitive scheduled parameter data (e.g., process variable parameter data, non-user-modifiable parameter data, etc.) from corresponding ones of the field devices 120.

If the process controller circuitry 202 determines that the PDD defines a scheduled DD parameter (block 326: YES), the process controller circuitry 202 puts the PDD into a scheduled dataset worker queue and sets a corresponding refresh interval (e.g., from a RefreshInterval property of the dataset obtained at block 310) as the time interval for the scheduled dataset worker queue (block 328). In examples disclosed herein, the refresh interval value is a customer-specific value that can be specified by a user/developer in the dataset obtained at block 310. For example, the process controller circuitry 202 can read the time-insensitive scheduled parameter data by processing the PDD in the scheduled dataset worker queue at the specified time interval and communicating with a corresponding one or more of the field devices 120 via the scheduled DD parameter read circuitry 115. In some examples, the refresh interval value may be short such as multiple seconds, one second, or less. In other examples, the refresh interval value may be longer such as one minute, 15 minutes, one hour, or more.

If the process controller circuitry 202 determines that the PDD does not define a scheduled DD parameter (block 326: NO), the process controller circuitry 202 logs a warning and ignores the PDD of block 316 (block 330). For example, the warning may be used to indicate to a user/developer of the client device 104 that the request 122 could not be processed. Control then returns to block 314.

Returning to block 306, if the process controller circuitry 202 determines a next device is not available (block 306: NO), the parameter monitor circuitry 102 reads user-modifiable configuration parameter data (block 332). Example instructions and/or operations that may be used to implement block 332 are described below in connection with FIG. 5. The parameter monitor circuitry 102 then reads scheduled parameter data (block 334). Example instructions and/or operations that may be used to implement block 334 are described below in connection with FIG. 6. Although blocks 332 and 334 are shown in seriatim, blocks 332 and 334 may alternatively be performed in parallel. The example instructions and/or operations 300 of FIG. 3 end.

FIG. 4 is a flowchart representative of example machine-readable instructions and/or example operations 303 that may be executed, instantiated, and/or performed by programmable circuitry to implement the parameter monitor circuitry 102 of FIGS. 1 and 2 to detect changes to a list of monitored field devices. The example instructions and/or operations 303 begin at block 402, at which the process controller circuitry 202 subscribes to monitored device changes. For example, the process controller circuitry 202 can subscribe to an OS service to be notified when changes are made by a user/developer to the list of monitored devices obtained at block 302 of FIG. 3.

At block 404, the process controller circuitry 202 detects changes to the list of monitored devices. For example, the process controller circuitry 202 can determine when a notification is received from the OS service indicating that a change (e.g., removal of a field device, addition of a field device, replacement/switching out of a field device, etc.) has been made to the list of monitored devices read at block 302 of FIG. 3. At block 406, the process controller circuitry 202 removes one or more deleted field devices 120 from the list of monitored devices. For example, the process controller circuitry 202 can remove one or more device identifier(s) (e.g., field device tags, field device identifiers, etc.) of the one or more deleted field devices 120 from the list of monitored devices read at block 302 of FIG. 3. The process controller circuitry 202 can perform this removal after determining from the notification generated by the OS service that a request has been made by the user/developer to delete one or more of the field devices 120 from the list of monitored devices. After removal of a field device from the list of monitored devices, that field device is not available in the list of monitored devices accessed at block 304 of FIG. 3.

At block 408, the process controller circuitry 202 determines whether one or more field devices 120 are to be added to the list of monitored devices. For example, the process controller circuitry 202 can determine from a notification generated by the OS service that a request has been made by the user/developer to add one or more of the field devices 120 to the list of monitored devices. If the process controller circuitry 202 determines that one or more of the field devices 120 are to be added to the list of monitored devices (block 408: YES), the process controller circuitry 202 adds one or more of the field devices 120 to the list of monitored devices (block 410). For example, the process controller circuitry 202 can add one or more device identifier(s) (e.g., field device tags, field device identifiers, etc.) of the field devices 120 to the list of monitored devices. If the process controller circuitry 202 determines that none of the field devices 120 are to be added to the list of monitored devices (block 408: NO), the process controller circuitry 202 does not modify the list of monitored devices (block 412). The example instructions and/or operations 303 end and control returns to a calling process or function, such as the example instructions and/or operations 300 of FIG. 3.

FIG. 5 is a flowchart representative of example machine-readable instructions and/or example operations 332 that may be executed, instantiated, and/or performed by programmable circuitry to implement the parameter monitor circuitry 102 of FIGS. 1 and 2 to monitor and/or read user-modifiable configuration parameters in the asset database 108 based on the on-modified DD-based parameter(s) 146 in the JSON input file schema 132. The instructions and/or operations 332 begin at block 502 at which the process controller circuitry 202 reads a user-modifiable configuration parameter count “n”. For example, the process controller circuitry 202 can read the user-modifiable configuration parameter count “n” from a “MaxOnModifiedParamCountToRead” variable in the JSON input file schema 132. The user-modifiable configuration parameter count “n” represents the number or quantity of user-modifiable configuration parameters defined in the on-modified DD-based parameter(s) 146 that are to be concurrently monitored for changes in the asset database 108 and/or read from the asset database 108. The user-modifiable configuration parameter count “n” can be selected by a user/developer. In some examples, the user-modifiable configuration parameter count “n” can be limited to a maximum quantity to avoid decreasing system performance of the parameter monitor circuitry 102 and/or the process control system server 106. Servers of more powerful computing capabilities can handle larger quantities for the user-modifiable configuration parameter count “n” than servers of less powerful computing capabilities.

At block 504, the process controller circuitry 202 creates a TPL dataflow producer. The TPL dataflow producer creates tasks or workers to read user-modifiable configuration parameter values that are detected as modified in the asset database 108. For example, if one monitored user-modifiable configuration parameter is detected as having been modified in the asset database 108, the TPL dataflow producer creates one task or worker that identifies the one modified user-modifiable configuration parameter to be read. As another example, if all of the monitored user-modifiable configuration parameters are detected as having been modified in the asset database 108, the TPL dataflow producer creates a quantity of tasks or workers equal to the user-modifiable configuration parameter count “n” that identify the monitored user-modifiable configuration parameters to be read.

At block 506, the process controller circuitry 202 creates one or more TPL dataflow consumer(s). For example, the process controller circuitry 202 creates a separate TPL dataflow consumer for each of the user-modifiable configuration parameters represented by the user-modifiable configuration parameter count “n”. The TPL dataflow consumers obtain tasks or workers from the TPL dataflow producer that identify modified user-modifiable configuration parameters in the asset database 108. As such, the process controller circuitry 202 creates a quantity of “n” TPL dataflow consumers so that up to “n” user-modifiable configuration parameter values can be obtained concurrently from the asset database 108 based on the tasks or workers.

At block 508, the interval controller circuitry 214 reads a parameter polling time interval value. For example, the interval controller circuitry 214 reads a parameter polling time interval value “a” from a time interval property in the JSON input file schema 132. The parameter polling time interval value “a” represents how often the parameter change detection poller circuitry 212 is to check for changes to the user-modifiable configuration parameters in the asset database 108.

In some examples, the interval controller circuitry 214 also reads a delay value “b” from the JSON input file schema 132 at block 508. In such examples, the delay value “b” represents an interval window limit for the reading of user-modifiable configuration parameters from the asset database 108. For example, the parameter polling time interval value “a” defines a parameter read window (ReadWindow) spanning between a previous parameter read time T0 and a current parameter read time T1 (e.g., ReadWindow(T1−T0). However, to account for delays between a user/developer requesting a change to a user-modifiable configuration parameter value and a time at which that change is actually committed in the asset database 108, the delay value “b” can be used.

To limit the parameter read window (ReadWindow) to exclude a trailing duration of the parameter read window, the trailing duration is defined by the delay value “b” (e.g., ReadWindow((T1−b)−T0)). For example, if the parameter read window (ReadWindow) is 10 milliseconds (ms) (e.g., timer interval value “a”=10 ms) and the delay value “b” is 1 ms (e.g., the delay value “b”=1 ms), the parameter read window (ReadWindow) is a duration of 9 ms starting from the previous parameter read time T0 and ending at the current parameter read time T1 minus the delay “b” (e.g., T1−b). In such an example, if the previous parameter read time T0 occurred 500 ms (T0=500 ms), the current parameter read time T1 is 510 ms (T1=510 ms) and the parameter read window spans between 500 ms and 509 ms (e.g., ReadWindow((510 ms−1 ms)−500 ms)=>ReadWindow(509 ms−500 ms)). In such example, user-modifiable configuration parameter values read in this adjusted parameter read window do not represent changes to user-modifiable configuration parameters requested by a user/developer at 509.5 ms but not committed in the asset database 108 until 510.5 ms. This substantially reduces or eliminates representing that all changes requested during the last 10 ms parameter read window interval are represented in the retrieved user-modifiable configuration parameter values during that parameter read window.

At block 510, the interval controller circuitry 214 executes the parameter polling time interval. For example, the interval controller circuitry 214 can set a countdown timer equal to the parameter polling time interval of block 508 and start the countdown timer. At block 512, the interval controller circuitry 214 checks the timer. At block 514, the interval controller circuitry 214 determines whether the timer has elapsed. In some examples, the checking of the timer at blocks 512 and 514 is performed by an OS function of the process control system server 106. If the interval controller circuitry 214 determines that the timer has not elapsed (block 514: NO), control returns to block 512.

If the interval controller circuitry 214 determines that the timer has elapsed (block 514: YES), the parameter change detection poller circuitry 212 calls the asset database 108 to access metadata associated with a list of one or more modified user-modifiable configuration parameter(s) (block 516). For example, the parameter change detection poller circuitry 212 can send a call to the asset database 108 through the database interface circuitry 204 which communicates with the asset database 108 through the user-modifiable parameter read circuitry 112. The call is used to query the asset database 108 to reply with a status and corresponding metadata of any user-modifiable configuration parameter that has been changed since the last time the parameter change detection poller circuitry 212 checked for changes. In the illustrated example, the query includes a time range (e.g., based on the parameter polling time interval value “a” (and/or the delay value “b”) of block 508) and a device network ID associated with ones of the field devices 120 associated with user-modifiable configuration parameters of interest. The metadata can include one or more device tags (e.g., names of the field devices 120 associated with modified user-modifiable configuration parameters), user-modifiable configuration parameter IDs, event times (e.g., timestamps indicating when user-modifiable configuration parameters were modified), device identifiers (e.g., field device IDs of the field devices 120 associated with modified user-modifiable configuration parameters), names/identifiers of client devices or workstations through which modifications were made, etc. In some examples, the metadata is read based on different groupings of the field devices 120. For example, the field devices 120 may be grouped on a field device network basis in which different field device networks are associated with corresponding network IDs, on a scheduled communication request read circuitry 114 (AmsCommService) basis in which different instances of the scheduled communication request read circuitry 114 (e.g., different AmsCommService instances) are in communication with different groupings of the field devices 120, and/or based on any other grouping criteria.

At block 518, the DD parameter reader circuitry 216 requests a next modified user-modifiable configuration parameter. For example, the DD parameter reader circuitry 216 can use a “GET” command to request a next modified user-modifiable configuration parameter from the list of modified user-modifiable configuration parameter(s) obtained at block 516. At block 519, the DD parameter reader circuitry 216 determines whether the request of block 518 resulted in a modified user-modifiable configuration parameter. If the request of block 518 did not result in a modified user-modifiable configuration parameter (block 519: NO), control returns to block 512. Otherwise, if the request of block 518 did result in a modified user-modifiable configuration parameter (block 519: YES), control advances to block 520.

At block 520, the DD parameter reader circuitry 216 compares the modified user-modifiable configuration parameter to a dataset description file of a corresponding field device 120 to determine whether the modified user-modifiable configuration parameter is identified as of interest for monitoring (e.g., is a monitored user-modifiable configuration parameter). For example, the DD parameter reader circuitry 216 may compare a parameter name (or a PDD) of the modified user-modifiable configuration parameter to parameter names (or PDDs) specified in the on-modified DD-based parameter(s) 146 of the dataset description file (e.g., the JSON input file schema 132). In some examples, a user/developer may generate/edit the on-modified DD-based parameter(s) 146 of the dataset description file via the client device 104 to identify user-modifiable configuration parameters that are of interest for monitoring in the asset database 108. If a user-modifiable configuration parameter is identified as of interest for monitoring, the parameter monitor circuitry 102 can provide or stream the value(s) of the user-modifiable configuration parameter when it has been modified in the asset database 108 (e.g., by another user/developer and/or by a process).

At block 522, the DD parameter reader circuitry 216 determines whether a modified value of a user-modifiable configuration parameter is a monitored user-modifiable configuration parameter. For example, if the comparison of block 520 results in a non-match, the DD parameter reader circuitry 216 determines at block 522 that a modified value of a user-modifiable configuration parameter corresponding to one of the field devices 120 is not monitored. Otherwise, if the comparison of block 520 results in a match, the DD parameter reader circuitry 216 determines at block 522 that the next modified user-modifiable configuration parameter value obtained at block 518 is monitored.

If the DD parameter reader circuitry 216 determines that a modified value of a user-modifiable configuration parameter is not monitored (block 522: NO), control returns to block 518. Otherwise, if the DD parameter reader circuitry 216 determines that a modified value of a user-modifiable configuration parameter is monitored (block 522: YES), the process controller circuitry 202 creates an active on-modified dataset worker (block 524). In the illustrated example, the active on-modified dataset worker (or task) is a thread or process used to read a value of the modified user-modifiable configuration parameter from the asset database 108. At block 526, the process controller circuitry 202 assigns the active on-modified dataset worker to a TPL dataflow producer, and control returns to block 518. For example, the process controller circuitry 202 assigns the active on-modified dataset worker to the TPL dataflow producer created at block 504. The TPL dataflow producer provides a corresponding task in a TPL dataflow consumer queue so that the task can be executed by a TPL dataflow consumer of block 506.

In the illustrated example, blocks 512, 514, 516, 518, 519, 520, 522, 524, and 526 can be performed iteratively based on the parameter polling time interval of block 508 to continuously monitor for changes to user-modifiable configuration parameters. Based on such iterative polling, the parameter monitor circuitry 102 can continuously stream modified value(s) of the user-modifiable configuration parameters to the client device 104 and/or any other interested client device.

At block 528, the process controller circuitry 202 checks a TPL dataflow consumer queue. For example, tasks (e.g., the active on-modified dataset workers of block 524) to be completed by the TPL dataflow consumer(s) of block 506 are placed in the TPL dataflow consumer queue. Such tasks include metadata (e.g., metadata obtained at block 516) of one or more user-modifiable configuration parameter(s) to be read from the asset database 108. The tasks cause the TPL dataflow consumer(s) to call the user-modifiable parameter read circuitry 112 (e.g., an AmsFDIService) to read the user-modifiable configuration parameter(s) from the asset database 108. In the illustrated example, multiple TPL dataflow consumers can call the user-modifiable parameter read circuitry 112 to read multiple user-modifiable configuration parameters from the asset database 108 concurrently. In the illustrated example of FIG. 5, a TPL dataflow consumer queue receives a task when the process controller circuitry 202 assigns an active on-modified dataset worker to a TPL dataflow producer at block 526. In some examples, the checking of the TPL dataflow consumer queue at block 528 is performed by an OS function of the process control system server 106.

At block 530, the process controller circuitry 202 determines whether any TPL dataflow consumer has work to do. For example, the process controller circuitry 202 determines that a TPL dataflow consumer has work to do when the TPL dataflow consumer queue checked at block 528 has a task (e.g., the active on-modified dataset workers of block 524) to read a modified user-modifiable configuration parameter from the asset database 108.

If the process controller circuitry 202 determines that no TPL dataflow consumer has work to do (block 530: NO), control returns to block 528. Otherwise, if the process controller circuitry 202 determines that one or more TPL dataflow consumer(s) has/have work to do (block 530: YES), the DD parameter reader circuitry 216 requests the modified value(s) of the user-modifiable configuration parameter(s) from the asset database 108 (block 532). For example, the DD parameter reader circuitry 216 creates and sends a read request or query to the database interface circuitry 204 which forwards the read request or query to the user-modifiable parameter read circuitry 112 so that the user-modifiable parameter read circuitry 112 can query the asset database 108 for the modified value(s) of the user-modifiable configuration parameter(s).

At block 534, the MQTT publisher circuitry 222 creates an MQTT message payload and topic. For example, the MQTT publisher circuitry 222 creates an MQTT message payload that includes the modified value(s) of the user-modifiable configuration parameter(s) of block 532 and a corresponding topic under which to publish the modified value(s) to subscribed client devices (e.g., the client device 104). At block 536, the MQTT publisher circuitry 222 publishes the topic to the broker circuitry 110 so that the modified value(s) in the corresponding message payload can be accessed by the client device 104 and/or any other subscribed client device. Control returns to block 530.

In the illustrated example, blocks 528, 530, 532, 534, and 536 can be performed iteratively to continuously read modified values of user-modifiable configuration parameters from the asset database 108. Based on such iterative readings, the parameter monitor circuitry 102 can continuously stream modified value(s) of the user-modifiable configuration parameters to the client device 104 and/or any other interested client device. Also, blocks 528, 530, 532, 534, and 536 can be performed concurrently with blocks 512, 514, 516, 518, 519, 520, 522, 524, and 526 so that any active on-modified dataset workers (or tasks) created based on blocks 512, 514, 516, 518, 519, 520, 522, 524, and 526 can be executed based on blocks 528, 530, 532, 534, and 536 on a rolling basis. The example instructions and/or operations 332 of FIG. 5 can end in response to receiving a shutdown command, an end command, or other instruction to stop the monitoring of user-modifiable configuration parameters in the asset database 108.

FIG. 6 is a flowchart representative of example machine-readable instructions and/or example operations 334 that may be executed, instantiated, and/or performed by programmable circuitry to implement the parameter monitor circuitry 102 of FIGS. 1 and 2 to read process variables from the field devices 120 based on the communication request definition(s) 142 in the JSON input file schema 132. The example instructions and/or operations 334 begin at block 602 at which the process controller circuitry 202 reads a scheduled dataset count “m”. For example, the process controller circuitry 202 can read the scheduled dataset count “m” from a “MaxScheduledDatasetCountToRead” variable in the JSON input file schema 132. The scheduled dataset count “m” represents the number or quantity of scheduled datasets of process variable parameter values that are specified in the communication request definition(s) 142 to be read concurrently from one or more of the field devices 120. The scheduled dataset count “m” can be selected by a user/developer. In some examples, the scheduled dataset count “m” can be limited to a maximum quantity to avoid decreasing system performance of the parameter monitor circuitry 102 and/or the process control system server 106. Servers of more powerful computing capabilities can handle larger quantities for the scheduled dataset count “m” than servers of less powerful computing capabilities.

At block 604, the process controller circuitry 202 creates a TPL dataflow producer. At block 606, the process controller circuitry 202 creates one or more TPL dataflow consumer(s). For example, the process controller circuitry 202 creates a separate TPL dataflow consumer for each of the scheduled datasets represented by the scheduled dataset count “m”. As such, the process controller circuitry 202 creates a quantity of “m” TPL dataflow consumers.

At block 608, the interval controller circuitry 214 checks a timer. For example, the timer tracks one or more interval schedules that indicate how often the communication request reader circuitry 208 is to read process variable data for one or more corresponding scheduled dataset worker(s) from the field devices 120. In examples disclosed herein, a scheduled dataset worker (or task) is a thread or process used to read a corresponding process variable data value from a field device 120. In some examples, the interval controller circuitry 214 obtains the one or more schedules for the timer from a dataset description file (e.g., the JSON input file schema 132). In some examples, block 608 can be performed by an OS function of the process control system server 106. At block 610, the interval controller circuitry 214 determines whether the timer has elapsed. If the interval controller circuitry 214 determines that the timer has not elapsed (block 610: NO), control returns to block 608. If the interval controller circuitry 214 determines that the timer has elapsed (block 610: YES), the process controller circuitry 202 assigns an active scheduled dataset worker to a TPL dataflow producer (block 612), and control returns to block 608. For example, the process controller circuitry 202 assigns the active scheduled dataset worker to the TPL dataflow producer created at block 604. The TPL dataflow producer provides a corresponding task in a TPL dataflow consumer queue so that the task can be executed by a TPL dataflow consumer of block 606.

In the illustrated example, blocks 608, 610, and 612 can be performed iteratively based on an interval schedule tracked by the timer at block 608 to continuously monitor for changes to user-modifiable configuration parameters. Accordingly, the parameter monitor circuitry 102 can continuously stream process variable value(s) of the field device(s) 120 to the client device 104 and/or any other interested client device.

At block 614, the process controller circuitry 202 checks a TPL dataflow consumer queue. For example, tasks (e.g., the active scheduled dataset worker(s) assigned at block 612) to be completed by the TPL dataflow consumer(s) of block 606 are placed in the TPL dataflow consumer queue. Such tasks include metadata (e.g., field device tags, field device identifiers, etc.) of ones of the field devices 120 from which process variables are to be read and cause the TPL dataflow consumer(s) to call the scheduled communication request read circuitry 114 (e.g., an AmsCommService) to read corresponding process variable values from the field device(s) 120. In the illustrated example, multiple TPL dataflow consumers can call the scheduled communication request read circuitry 114 to read values from multiple process variables of the field device(s) 120 concurrently. In the illustrated example of FIG. 6, a TPL dataflow consumer queue receives a task when the process controller circuitry 202 assigns an active scheduled dataset worker to a TPL dataflow producer at block 612. In some examples, the checking of the TPL dataflow consumer queue at block 614 is performed by an OS function of the process control system server 106.

At block 616, the process controller circuitry 202 determines whether any TPL dataflow consumer has work to do. For example, the process controller circuitry 202 determines that a TPL dataflow consumer has work to do when the TPL dataflow consumer queue checked at block 614 has a task (e.g., the active scheduled dataset worker(s) assigned at block 612) to read process variable(s) from the field device(s) 120.

If the process controller circuitry 202 determines that no TPL dataflow consumer has work to do (block 616: NO), control returns to block 614. Otherwise, if the process controller circuitry 202 determines that one or more TPL dataflow consumer(s) has/have work to do (block 616: YES), the communication request encoder circuitry 206 generates the binary frame 134 (e.g., a field device request) based on the request 122 (block 618). For example, the communication request encoder circuitry 206 generates the binary frame 134 based on a request property (e.g., a RequestParams property) associated with the communication request definition(s) 142 in the JSON input file schema 132 in the request 122. In the illustrated example, control returns to block 616 to monitor for any other work in a TPL dataflow consumer and concurrently advances in parallel to block 620.

At block 620, the communication request reader circuitry 208 requests to read requested process variable data from one or more of the field device(s) 120. For example, the communication request reader circuitry 208 creates and sends a read request or query based on the binary frame 134 to the scheduled communication request read circuitry 114 which uses the read request or query to read the requested process variable data from the one or more field device(s) 120.

At block 622, the communication request decoder circuitry 218 parses the binary reply 136. For example, the communication request decoder circuitry 218 parses the binary reply 136 and converts process variable data in the binary reply 136 from a binary format to a JSON format to generate and/or write into the output schema 138.

At block 624, the MQTT publisher circuitry 222 creates an MQTT message payload and topic. For example, the MQTT publisher circuitry 222 creates an MQTT message payload that includes the retrieved process variable value(s) in the output schema 138 and a corresponding topic under which to publish the process variable value(s) to subscribed client devices (e.g., the client device 104). At block 626, the MQTT publisher circuitry 222 publishes the topic to the broker circuitry 110 so that the process variable value(s) in the corresponding message payload can be accessed by the client device 104 and/or any other subscribed client device. Control returns to block 614.

In the illustrated example, blocks 614, 616, 618, 620, 622, 624, and 626 can be performed iteratively to continuously read process variable values from the field device(s) 120. Based on such iterative readings, the parameter monitor circuitry 102 can continuously stream process variable value(s) of the field device(s) 120 to the client device 104 and/or any other interested client device. Also, blocks 614, 616, 618, 620, 622, 624, and 626 can be performed with blocks 608, 610, and 612 so that any scheduled data set workers (or tasks) created based on blocks 608, 610, and 612 can be executed based on blocks 614, 616, 618, 620, 622, 624, and 626 on a rolling basis. The example instructions and/or operations 334 of FIG. 6 can end in response to receiving a shutdown command, an end command, or other instruction to stop the monitoring of the scheduled dataset(s) in the field devices 120.

FIG. 7 is a flowchart representative of example machine-readable instructions and/or example operations 700 that may be executed, instantiated, and/or performed by programmable circuitry to implement the parameter monitor circuitry 102 of FIGS. 1 and 2 to access device parameter data. For example, the instructions and/or operations 700 can be used to access modified value(s) of one or more user-modifiable configuration parameters in the asset database 108 and process variable(s) of scheduled dataset(s) from one or more field devices 120 concurrently based on one or more parameter IDs and/or one or more commands/instructions in the request 122 from the client device 104. For example, the instructions and/or operations 700 can be used to access device parameter data based on the communication request definition(s) 142, the scheduled DD-based parameter(s) 144, and/or the on-modified DD-based parameter(s) 146 in the JSON input file schema 132.

The instructions and/or operations 700 begin at block 702 at which the process controller circuitry 202 accesses a client request (e.g., the request 122) for device parameter data. The device parameter data is associated with one or more of the field device(s) 120 in a process control system. At block 704, the process controller circuitry 202 accesses the JSON input file schema 132 (e.g., a first-format file) from the request 122. The JSON input file schema 132 includes at least one parameter ID and/or at least one instruction or command to retrieve device parameter data associated with at least one of the field devices 120.

At block 706, the communication request encoder circuitry 206 converts the JSON input file schema 132 to a field device request (e.g., a second-format file). For example, the communication request encoder circuitry 206 converts one or more instructions (or commands) in the communication request definition(s) 142 of the JSON input file schema 132 to a binary format to generate the binary frame 134 (e.g., the field device request).

At block 708, the communication request reader circuitry 208 transmits the field device request (e.g., the binary frame 134) to the scheduled communication request read circuitry 114 to cause access of a process variable value (e.g., a first device parameter value) of the device parameter data in the at least one of the field devices 120 based on the field device request. For example, the scheduled communication request read circuitry 114 is to execute the field device request (e.g., the binary frame 134) to access the process variable value in the at least one of the field devices 120 (e.g., via the controller(s) 118). In some examples, the communication request reader circuitry 208 caches the field device request and transmits the field device request (e.g., the binary frame 134) to the scheduled communication request read circuitry 114 at periodic intervals (e.g., seconds, minutes, hours, etc.) (or aperiodically) to obtain refreshed process variable values over time from the at least one of the field devices 120. This enables the parameter monitor circuitry 102 to stream the refreshed process variable values back to the client device 104 over time.

At block 710, the DD parameter reader circuitry 216 queries the asset database 108 via the user-modifiable parameter read circuitry 112 to retrieve at least one modified value(s) (e.g., a second device parameter value) of user-modifiable configuration parameter data (e.g., of the device parameter data). For example, the DD parameter reader circuitry 216 can generate a query based on the on-modified DD-based parameter(s) 146 of the JSON input file schema 132 and send the query to the database interface circuitry 204 which forwards the query to the user-modifiable parameter read circuitry 112. In the illustrated example, the DD parameter reader circuitry 216 queries the asset database 108 after a change to the user-modifiable configuration parameter data of interest has been detected as described above in connection with FIG. 5. In some examples, the detected change is a first detected change of multiple detected changes to the user-modifiable configuration parameter data of interest, and the DD parameter reader circuitry 216 queries the asset database 108 for the multiple detected changes. In some examples, the DD parameter reader circuitry 216 caches the query and sends the query to the asset database 108 at a periodic time interval (e.g., seconds, minutes, hours, etc.) (or aperiodically) to retrieve modified value(s) of user-modifiable configuration parameter data of interest as described above in connection with FIG. 5. This enables the parameter monitor circuitry 102 to stream the modified user-modifiable configuration parameter values back to the client device 104 over time.

At block 712, the process controller circuitry 202 transmits a field device request based on the scheduled DD-based parameter(s) 144 to the scheduled DD parameter read circuitry 115. For example, the process controller circuitry 202 can generate a field device request that includes commands specifying one or more parameter ID(s) of process variable(s) to read from one or more of the field devices 120. The field device request causes the scheduled DD parameter read circuitry 115 to read the process variable(s) from the one or more field devices 120 (e.g., via the controller(s) 118). In some examples, the process controller circuitry 202 caches the field device request and sends the field device request to the scheduled DD parameter read circuitry 115 at a periodic time interval (e.g., seconds, minutes, hours, etc.) (or aperiodically) to obtain refreshed process variable values over time from the at least one of the field devices 120. This enables the parameter monitor circuitry 102 to stream the refreshed process variable values back to the client device 104 over time.

Although blocks 708, 710, and 712 are shown in series, blocks 708, 710, and 712 can be performed in parallel. In some examples, blocks 708, 710, and 712 are performed based on a single command or instruction in the request 122 that specifies both the process variable(s) that is/are to be read from the field device(s) 120 and the user-modifiable configuration parameter(s) that is/are to be read from the asset database 108. Alternatively, block 708 is performed based on one command or instruction in the request 122 that specifies the process variable(s) that is/are to be read from the field device(s) 120, block 710 is performed based on one or more parameter ID(s) in the request 122 specifying the user-modifiable configuration parameter(s) that is/are to be read from the asset database 108, and block 712 is performed based on another command or instruction in the request 122 that includes one or more DD-based parameter(s) specifying parameter ID(s) of process variable(s) to be read from the field device(s) 120.

In some examples, the parameter monitor circuitry 102 performs less than all of blocks 708, 710, and 712. For example, if the JSON input file schema 132 does not include all three of the communication request definition(s) 142, the scheduled DD-based parameter(s) 144, and the on-modified DD-based parameter(s) 146, the parameter monitor circuitry 102 performs one(s) of the blocks 708, 710, and 712 corresponding to the type of request(s) made in the JSON input file schema 132.

At block 714, the MQTT publisher circuitry 222 sends the device parameter data retrieved at block 708, block 710, and/or block 712 to the client device 104 in response to the request 122. In some examples, the MQTT publisher circuitry 222 sends different, refreshed values for the device parameter data to the client device substantially continuously in streaming fashion (e.g., streamed updates within seconds, minutes, hours, etc.) based on the scheduled communication request read circuitry 114 and/or the scheduled DD parameter read circuitry 115 continuously reading process variable data from the field device(s) 120 and/or based on the user-modifiable parameter read circuitry 112 continuously reading user-modifiable configuration parameter data from the asset database 108. The example instructions and/or operations 700 end.

FIG. 8 is a block diagram of an example programmable circuitry platform 800 structured to execute and/or instantiate the example machine-readable instructions and/or the example operations of FIGS. 3-7 to implement the circuitry of FIGS. 1 and 2. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example parameter monitor circuitry 102, the example broker circuitry 110, the example user-modifiable parameter read circuitry 112, the example scheduled communication request read circuitry 114, the scheduled DD parameter read circuitry 115, the example process controller circuitry 202, the example database interface circuitry 204, the example communication request encoder circuitry 206, the example communication request reader circuitry 208, the example parameter change detection poller circuitry 212, the example interval controller circuitry 214, the example DD parameter reader circuitry 216, the example communication request decoder circuitry 218, and the example MQTT publisher circuitry 222.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 832, which may be implemented by the machine-readable instructions of FIGS. 3-7, may be stored in the mass storage device 828, in the volatile memory 814, in the non-volatile memory 816, and/or on at least one non-transitory computer-readable storage medium such as a CD or DVD which may be removable.

FIG. 13 is a block diagram of an example implementation of the programmable circuitry 812 of FIG. 8. In this example, the programmable circuitry 812 of FIG. 8 is implemented by a microprocessor 1300. For example, the microprocessor 1300 may be a general-purpose microprocessor (e.g., general-purpose microprocessor circuitry). The microprocessor 1300 and/or components thereof may include additional and/or alternate structures to those shown and described below. The microprocessor 1300 is a semiconductor device fabricated to include transistors interconnected to implement the structures described below in one or more integrated circuits (ICs) contained in one or more packages.

The microprocessor 1300 executes machine-readable instructions of the flowcharts of FIGS. 3-7 to instantiate the circuitry of FIGS. 1 and 2 as logic circuits to perform operations corresponding to those machine-readable instructions. In some such examples, the circuitry of FIGS. 1 and 2 is instantiated by the hardware circuits of the microprocessor 1300 in combination with the machine-readable instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine-readable instructions. For example, machine code corresponding to a firmware program, an embedded software program, or a software program represented by the flowchart(s) of FIGS. 3-7 may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 3-7.

The cores 1302 may communicate by a first example bus 1304. For example, the first bus 1304 may be implemented by any suitable bus technology (e.g., an Inter-Integrated Circuit (I2C) bus, a Serial Peripheral Interface (SPI) bus, a PCI bus, a PCIe bus etc.). Data, instructions, and/or signals may be communicated (e.g., accessed, obtained, output, provided, etc.) between the cores 1302 and one or more external devices by example interface circuitry 1306. Although the cores 1302 of this example include example local cache 1320 (e.g., Level 1 (L1) cache that may be split into an L1 data cache and an L1 instruction cache), the microprocessor 1300 also includes example shared cache 1310. The shared cache 1310 is shared by the cores (e.g., Level 2 (L2 cache)) to access data and/or instructions across the cores.

Each core 1302 includes control unit circuitry 1314, arithmetic and logic (AL) circuitry (sometimes referred to as an arithmetic logic unit (ALU)) 1316, a plurality of registers 1318 (e.g., hardware registers), the local cache 1320, and a second example bus 1322. The control unit circuitry 1314 controls (e.g., coordinates) data movement within the corresponding core 1302. The AL circuitry 1316 performs one or more mathematic and/or logic operations on the data within the corresponding core 1302.

The registers 1318 store data and/or instructions such as results of operations performed by the AL circuitry 1316. The second bus 1322 may be implemented using any suitable bus technology (e.g., an I2C bus, a SPI bus, a PCI bus, or a PCIe bus, etc.).

FIG. 14 is a block diagram of another example implementation of the programmable circuitry 812 of FIG. 8. In this example, the programmable circuitry 812 is implemented by FPGA circuitry 1400. Programmable logic circuitry of the FPGA circuitry 1400 may be programmed to create dedicated logic circuits that perform operations and/or functions represented in the flowchart(s) of FIGS. 3-7. For example, the FPGA circuitry 1400 includes interconnections and logic circuitry (e.g., logic gates, switches, etc.) that may be configured, structured, programmed, and/or interconnected in different ways to instantiate some or all of the operations/functions corresponding to the machine-readable instructions represented by the flowchart(s) of FIGS. 3-7. After an FPGA programming process, the FPGA circuitry 1400 instantiates the operations and/or functions corresponding to the machine-readable instructions in hardware. In some examples, the FPGA circuitry 1400 can execute the operations/functions faster than they could be performed by a general-purpose microprocessor.

The FPGA circuitry 1400 of FIG. 14, includes example input/output (I/O) circuitry 1402 to obtain data from and/or output data to example configuration circuitry 1404 and/or external hardware 1406 (e.g., microprocessor circuitry, controller circuitry, memory circuitry, storage circuitry, a computer, etc.). For example, the configuration circuitry 1404 may be implemented by interface circuitry that obtains a binary file to program or configure the FPGA circuitry 1400.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to machine-readable instructions of FIGS. 3-7 and/or other desired operations.

The storage circuitry 1412 is structured to store result(s) of operations performed by corresponding logic gates. The storage circuitry 1412 may be implemented by registers or the like.

Although not shown, the example FPGA circuitry 1400 of FIG. 14 also includes example dedicated operations circuitry to implement functions without programming those functions in the logic gate circuitry 1408. The FPGA circuitry 1400 may also include general purpose programmable circuitry such as a CPU, a DSP, etc.

Although FIGS. 13 and 14 illustrate two example implementations of the programmable circuitry 812 of FIG. 8, many other approaches are contemplated. For example, a hybrid circuitry example may include one or more cores 1302 of FIG. 13 that execute(s) a first portion of the machine-readable instructions represented by the flowchart(s) of FIGS. 3-7 to perform first operation(s)/function(s), and/or include the FPGA circuitry 1400 of FIG. 14 configured and/or structured to perform second operation(s)/function(s) corresponding to a second portion of the machine-readable instructions represented by the flowcharts of FIG. 3-7, and/or include an ASIC configured and/or structured to perform third operation(s)/function(s) corresponding to a third portion of the machine-readable instructions represented by the flowcharts of FIGS. 3-7.

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In some examples, the programmable circuitry 812 of FIG. 8 may be in one or more packages. For example, the microprocessor 1300 of FIG. 13 and/or the FPGA circuitry 1400 of FIG. 14 may be in one or more packages.

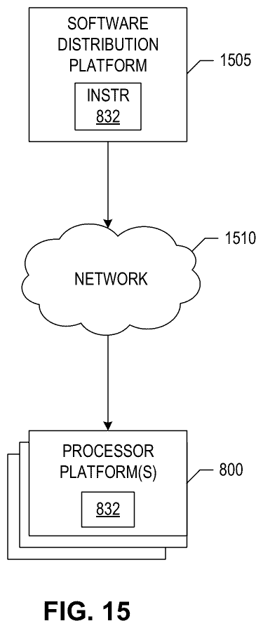

A block diagram illustrating an example software distribution platform 1505 to distribute software such as the example machine readable instructions 832 of FIG. 8 to other hardware devices (e.g., hardware devices owned and/or operated by third parties from the owner and/or operator of the software distribution platform) is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 832, which may correspond to the example machine readable instructions of FIGS. 3-7, as described above. The one or more servers of the example software distribution platform 1505 are in communication with an example network 1510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1505. For example, the software, which may correspond to the example machine readable instructions of FIG. 3-7, may be downloaded to the example programmable circuitry platform 800, which is to execute the machine readable instructions 832 to implement the parameter monitor circuitry 102. In some examples, one or more servers of the software distribution platform 1505 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

From the foregoing, it will be appreciated that example systems, apparatus, articles of manufacture, and methods have been disclosed that enable an example client device to describe and/or specify device parameters to monitor from a remote location (e.g., a location different from a process control system). For example, disclosed examples employ a JSON file that includes commands (or instructions) and/or parameter IDs to access device parameter data. Further, disclosed examples enable an example server communicatively coupled to such a process control system to execute the commands (or instructions) and/or use the parameter IDs in the JSON file to monitor the requested device parameter data over time and transmit (e.g., stream) the monitored device parameter data back to the client device. Disclosed systems, apparatus, articles of manufacture, and methods improve the efficiency of using a computing device by continuously monitoring device parameters in an example process control system based on a single request from a client device. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to monitor device parameters are disclosed herein. Further examples and combinations thereof include the following:

Example 1 includes an apparatus comprising interface circuitry, first instructions, and programmable circuitry to at least one of instantiate or execute the first instructions to access a file in a request from a client device, the file including at least a second instruction to retrieve device parameter data associated with at least one field device in a process control system, convert the at least the second instruction of the file from a first format to a field device request in a second format, cause access of a first device parameter value of the device parameter data in the at least one field device based on the field device request, query a database to retrieve a second device parameter value of the device parameter data, and provide the first device parameter value and the second device parameter value to the client device.

Example 2 includes the apparatus of example 1, wherein the device parameter data includes at least one of a process control value, an alarm, status information, diagnostic information, an error message, or a device identifier associated with the at least one field device.

Example 3 includes the apparatus of example 1 and/or example 2, wherein the programmable circuitry is to send different values for the device parameter data to the client device continuously.

Example 4 includes the apparatus of one or more of examples 1-3, wherein the programmable circuitry is to detect a change associated with the device parameter data, and send changed device parameter data to the client device based on the change.

Example 5 includes the apparatus of one or more of examples 1-4, wherein the detected change is a first detected change of multiple detected changes, wherein the programmable circuitry is to query the database for the multiple detected changes.

Example 6 includes the apparatus of one or more of examples 1-5, wherein the programmable circuitry is to periodically query the database based on a time interval.

Example 7 includes the apparatus of one or more of examples 1-6, wherein the file includes parameter identifiers to be used to query the database for the multiple detected changes.

Example 8 includes the apparatus of one or more of examples 1-7, wherein the parameter identifiers are to be used to query the database concurrently with execution of the at least the second instruction.

Example 9 includes the apparatus of one or more of examples 1-8, wherein the second device parameter value of the device parameter data corresponds to a user-modifiable configuration parameter associated with the at least one field device.

Example 10 includes a non-transitory machine-readable storage medium comprising first instructions to cause programmable circuitry to at least access a file in a request from a client device, the file including at least a second instruction to retrieve device parameter data associated with at least one field device in a process control system, convert the at least the second instruction of the file from a first format to a field device request in a second format, cause access of a first device parameter value of the device parameter data in the at least one field device based on the field device request, query a database to retrieve a second device parameter value of the device parameter data, and provide the first device parameter value and the second device parameter value to the client device.

Example 11 includes the non-transitory machine-readable storage medium of example 10, wherein the device parameter data includes at least one of a process control value, an alarm, status information, diagnostic information, an error message, or a device identifier associated with the at least one field device.

Example 12 includes the non-transitory machine-readable storage medium of example 10 and/or example 11, wherein the first instructions, when executed or instantiated by the programmable circuitry, is to cause the programmable circuitry to send different values for the device parameter data to the client device continuously.

Example 13 includes the non-transitory machine-readable storage medium of one or more of examples 10-12, wherein the first instructions, when executed or instantiated by the programmable circuitry, are to cause the programmable circuitry to detect a change associated with the device parameter data, and send changed device parameter data to the client device based on the change.

Example 14 includes the non-transitory machine-readable storage medium of one or more of examples 10-13, wherein the detected change is a first detected change of multiple detected changes, wherein the first instructions, when executed or instantiated by the programmable circuitry, are to cause the programmable circuitry to query the database for the multiple detected changes.

Example 15 includes the non-transitory machine-readable storage medium of one or more of examples 10-14, wherein the first instructions, when executed or instantiated by the programmable circuitry, are to cause the programmable circuitry to periodically query the database based on a time interval.

Example 16 includes the non-transitory machine-readable storage medium of one or more of examples 10-15, wherein the file includes parameter identifiers to be used to query the database for the multiple detected changes.

Example 17 includes the non-transitory machine-readable storage medium of one or more of examples 10-16, wherein the parameter identifiers are to be used to query the database concurrently with execution of the at least the second instruction.

Example 18 includes the non-transitory machine-readable storage medium of one or more of examples 10-17, wherein the second device parameter value of the device parameter data corresponds to a user-modifiable configuration parameter associated with the at least one field device.

Example 19 includes a method comprising accessing a file in a request from a client device, the file including at least a second instruction to retrieve device parameter data associated with at least one field device in a process control system, converting the at least the second instruction of the file from a first format to a field device request in a second format, causing access of a first device parameter value of the device parameter data in the at least one field device based on the field device request, querying a database to retrieve a second device parameter value of the device parameter data, and providing the first device parameter value and the second device parameter value to the client device.

Example 20 includes the method of example 19, further including streaming different values for the device parameter data to the client device continuously.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
first instructions; and
programmable circuitry to at least one of instantiate or execute the first instructions to:
access a file in a request from a client device, the file including at least a second instruction to retrieve device parameter data associated with at least one field device in a process control system;
convert the at least the second instruction of the file from a first format to a field device request in a second format;
cause access of a first device parameter value of the device parameter data in the at least one field device based on the field device request;
query a database to retrieve a second device parameter value of the device parameter data; and
provide the first device parameter value and the second device parameter value to the client device.

2. The apparatus of claim 1, wherein the device parameter data includes at least one of a process control value, an alarm, status information, diagnostic information, an error message, or a device identifier associated with the at least one field device.

3. The apparatus of claim 1, wherein the programmable circuitry is to send different values for the device parameter data to the client device continuously.

4. The apparatus of claim 1, wherein the programmable circuitry is to:
detect a change associated with the device parameter data; and
send changed device parameter data to the client device based on the change.

5. The apparatus of claim 4, wherein the detected change is a first detected change of multiple detected changes, wherein the programmable circuitry is to query the database for the multiple detected changes.

6. The apparatus of claim 5, wherein the programmable circuitry is to periodically query the database based on a time interval.

7. The apparatus of claim 5, wherein the file includes parameter identifiers to be used to query the database for the multiple detected changes.

8. The apparatus of claim 7, wherein the parameter identifiers are to be used to query the database concurrently with execution of the at least the second instruction.

9. The apparatus of claim 1, wherein the second device parameter value of the device parameter data corresponds to a user-modifiable configuration parameter associated with the at least one field device.

10. A non-transitory machine-readable storage medium comprising first instructions to cause programmable circuitry to at least:
access a file in a request from a client device, the file including at least a second instruction to retrieve device parameter data associated with at least one field device in a process control system;
convert the at least the second instruction of the file from a first format to a field device request in a second format;
cause access of a first device parameter value of the device parameter data in the at least one field device based on the field device request;
query a database to retrieve a second device parameter value of the device parameter data; and
provide the first device parameter value and the second device parameter value to the client device.

11. The non-transitory machine-readable storage medium of claim 10, wherein the device parameter data includes at least one of a process control value, an alarm, status information, diagnostic information, an error message, or a device identifier associated with the at least one field device.

12. The non-transitory machine-readable storage medium of claim 10, wherein the first instructions, when executed or instantiated by the programmable circuitry, is to cause the programmable circuitry to send different values for the device parameter data to the client device continuously.

13. The non-transitory machine-readable storage medium of claim 10, wherein the first instructions, when executed or instantiated by the programmable circuitry, are to cause the programmable circuitry to:
detect a change associated with the device parameter data; and
send changed device parameter data to the client device based on the change.

14. The non-transitory machine-readable storage medium of claim 13, wherein the detected change is a first detected change of multiple detected changes, wherein the first instructions, when executed or instantiated by the programmable circuitry, are to cause the programmable circuitry to query the database for the multiple detected changes.

15. The non-transitory machine-readable storage medium of claim 14, wherein the first instructions, when executed or instantiated by the programmable circuitry, are to cause the programmable circuitry to periodically query the database based on a time interval.

16. The non-transitory machine-readable storage medium of claim 14, wherein the file includes parameter identifiers to be used to query the database for the multiple detected changes.

17. The non-transitory machine-readable storage medium of claim 16, wherein the parameter identifiers are to be used to query the database concurrently with execution of the at least the second instruction.

18. The non-transitory machine-readable storage medium of claim 10, wherein the second device parameter value of the device parameter data corresponds to a user-modifiable configuration parameter associated with the at least one field device.

19. A method comprising:
accessing a file in a request from a client device, the file including at least a second instruction to retrieve device parameter data associated with at least one field device in a process control system;
converting the at least the second instruction of the file from a first format to a field device request in a second format;
causing access of a first device parameter value of the device parameter data in the at least one field device based on the field device request;
querying a database to retrieve a second device parameter value of the device parameter data; and
providing the first device parameter value and the second device parameter value to the client device.

20. The method of claim 19, further including streaming different values for the device parameter data to the client device continuously.
